(19) United States
(12) Patent Application Publication
(10) Pub. No.: US 2025/0318001 A1
(43) Pub. Date: Oct. 9, 2025

(54) PROTOCOL DATA UNIT SESSIONS USING A NON-INTEGRATED ACCESS

(71) Applicant: QUALCOMM Incorporated, San Diego, CA (US)

(72) Inventors: Dario Serafino TONESI, San Diego, CA (US); Stefano FACCIN, San Ysidro, CA (US); Sunghoon KIM, San Diego, CA (US)

(21) Appl. No.: 18/984,702

(22) Filed: Dec. 17, 2024

Related U.S. Application Data
(60) Provisional application No. 63/574,110, filed on Apr. 3, 2024.

(51) Int. Cl. H04W 76/15; H04W 76/20; H04W 80/06

(52) U.S. Cl. CPC H04W 76/15; H04W 76/20; H04W 80/06

(57) ABSTRACT

Methods, systems, and devices for wireless communications using a protocol data unit (PDU) session over a non-integrated access when an integrated access is unavailable or unused are described. In some examples, a UE may transmit a request to establish a PDU session for communications between the UE and a network function. The PDU session may include a first access that is integrated in a network and a second access that is non-integrated in the network, or may only include the second access. The UE and the network function may communicate via the second access in accordance with communication rules. In some examples, the rules may indicate behavior for the UE and the network function over the second access when the first access is unavailable at the UE. In some other examples, the rules may indicate behavior for the UE and the network function when only using the second access.

### CROSS REFERENCE

The present Application for Patent claims benefit of U.S. Provisional Patent Application No. 63/574,110 by Tonesi et al., entitled “PROTOCOL DATA UNIT SESSIONS USING A NON-INTEGRATED ACCESS,” filed Apr. 3, 2024, which is assigned to the assignee hereof, and which is expressly incorporated by reference in its entirety herein.

### FIELD OF TECHNOLOGY

The following relates to wireless communications, including protocol data unit sessions using a non-integrated access when an integrated access is unavailable or unused.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support protocol data unit sessions using a non-integrated access. For example, the described techniques provide for a UE communicating with a user plane function (UPF) of a network via a non-integrated access when an integrated access is unavailable or unused. In some examples, the UE may transmit a request for establishment of a protocol data unit (PDU) session for communications between the UE and the UPF. In some examples, the PDU session may include a first access that is integrated in the network and a second access that is non-integrated in the network. In some other examples, the PDU session may only include the second access. A session management function (SMF) of the network may establish the PDU session and may indicate one or more communication rules to the UE and the UPF. The UE and the second network function may communicate via the second access in accordance with the communication rules. In some examples, the one or more communication rules may indicate behavior for the UE and the second network function when communicating over the second access when the first access is unavailable at the UE. In some other examples, the one or more communication rules may indicate behavior for the UE and the second network function when communicating using only the second access.

A method for wireless communications by a UE is described. The method may include transmitting, to a first network function of a first network and via a first access, a request to establish a PDU session for communications between the UE and a second network function over a first access, the request including a request to establish a connection with the second network function via a second access different from the first access, receiving, from a first network function, an indication of rules for communications between the UE and the second network function using the second access if the first access is unavailable, establishing a first connection with the second network function via the first access and a second connection with the second network function via the second access, and adjusting the second connection in accordance with the rules and based on an expiration of a timer.

A UE for wireless communications is described. The UE may include one or more memories storing processor executable code, and one or more processors coupled with the one or more memories. The one or more processors may individually or collectively be operable to execute the code to cause the UE to transmit, to a first network function of a first network and via a first access, a request to establish a PDU session for communications between the UE and a second network function over a first access, the request including a request to establish a connection with the second network function via a second access different from the first access, receive, from a first network function, an indication of rules for communications between the UE and the second network function using the second access if the first access is unavailable, establish a first connection with the second network function via the first access and a second connection with the second network function via the second access, and adjust the second connection in accordance with the rules and based on an expiration of a timer.

Another UE for wireless communications is described. The UE may include means for transmitting, to a first network function of a first network and via a first access, a request to establish a PDU session for communications between the UE and a second network function over a first access, the request including a request to establish a connection with the second network function via a second access different from the first access, means for receiving, from a first network function, an indication of rules for communications between the UE and the second network function using the second access if the first access is unavailable, means for establishing a first connection with the second network function via the first access and a second connection with the second network function via the second access, and means for adjusting the second connection in accordance with the rules and based on an expiration of a timer.

A non-transitory computer-readable medium storing code for wireless communications is described. The code may include instructions executable by one or more processors to transmit, to a first network function of a first network and via a first access, a request to establish a PDU session for communications between the UE and a second network function over a first access, the request including a request to establish a connection with the second network function via a second access different from the first access, receive, from a first network function, an indication of rules for communications between the UE and the second network function using the second access if the first access is unavailable, establish a first connection with the second network function via the first access and a second connection with the second network function via the second access, and adjust the second connection in accordance with the rules and based on an expiration of a timer.

In some examples of the method, UEs, and non-transitory computer-readable medium described herein, adjusting the second connection may include operations, features, means, or instructions for terminating the second connection immediately upon expiration of the timer, terminating the second connection in accordance with a duration upon expiration of a timer, and maintaining the second connection.

In some examples of the method, UEs, and non-transitory computer-readable medium described herein, the first network may be a Third-Generation Partnership Program (3GPP) network, the first network function may be an SMF, and the second network function may be a UPF.

In some examples of the method, UEs, and non-transitory computer-readable medium described herein, the first access may be a 3GPP access and the second access may be a non-integrated non-3GPP access.

In some examples of the method, UEs, and non-transitory computer-readable medium described herein, the first access may be integrated in the first network and the second access may be non-integrated in the first network.

In some examples of the method, UEs, and non-transitory computer-readable medium described herein, the first connection and the second connection may be a multipath QUIC (MPQUIC) connection or a multipath transmission control protocol (MPTCP) connection.

A method for wireless communications by a first network function is described. The method may include receiving via a first access, a request to establish a PDU session for communications between a UE and a second network function over a first access, the request including a request to establish a connection with the second network function via a second access different from the first access, establishing a PDU session for communications between the UE and the second network function based on receiving the request to establish the PDU session, and transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

A first network function for wireless communications is described. The first network function may include one or more memories storing processor executable code, and one or more processors coupled with the one or more memories. The one or more processors may individually or collectively be operable to execute the code to cause the first network function to receive via a first access, a request to establish a PDU session for communications between a UE and a second network function over a first access, the request including a request to establish a connection with the second network function via a second access different from the first access, establish a PDU session for communications between the UE and the second network function based on receiving the request to establish the PDU session, and transmit an indication of a first set of rules for communications between the UE and the second network function using the second access if the first access is unavailable to the UE and transmitting an indication of a second set of rules for communications between the UE and the second network function using the second access if the first access is unavailable to the second network function.

Another first network function for wireless communications is described. The first network function may include means for receiving via a first access, a request to establish a PDU session for communications between a UE and a second network function over a first access, the request including a request to establish a connection with the second network function via a second access different from the first access, means for establishing a PDU session for communications between the UE and the second network function based on receiving the request to establish the PDU session, and means for transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

A non-transitory computer-readable medium storing code for wireless communications is described. The code may include instructions executable by one or more processors to receive via a first access, a request to establish a PDU session for communications between a UE and a second network function over a first access, the request including a request to establish a connection with the second network function via a second access different from the first access, establish a PDU session for communications between the UE and the second network function based on receiving the request to establish the PDU session, and transmit an indication of a first set of rules for communications between the UE and the second network function using the second access if the first access is unavailable to the UE and transmitting an indication of a second set of rules for communications between the UE and the second network function using the second access if the first access is unavailable to the second network function.

Some examples of the method, first network functions, and non-transitory computer-readable medium described herein may further include operations, features, means, or instructions for receiving, from the second network function, an indication of UE activity using the first access and transmitting, to the second network function, an indication of an availability of the UE for communications with the second network function over the first access.

In some examples of the method, first network functions, and non-transitory computer-readable medium described herein, the first set of rules include access traffic steering, switching and splitting (ATSSS) rules and where the second set of rules include N4 rules.

In some examples of the method, first network functions, and non-transitory computer-readable medium described herein, the first network function may be an SMF and the second network function may be a UPF.

In some examples of the method, first network functions, and non-transitory computer-readable medium described herein, the first access may be integrated in a first network and the second access may be non-integrated in the first network, and where the first network may be a 3GPP network.

In some examples of the method, first network functions, and non-transitory computer-readable medium described herein, the first access may be a 3GPP access and the second access may be a non-integrated non-3GPP access.

A method for wireless communications by a second network function is described. The method may include receiving, from a first network function of the first network, an indication of rules for communications between a UE and the second network function using a second access if a first access is unavailable, transmitting, to the first network function, an indication of UE activity using the first access, receiving, from the first network function, an indication of an availability of the UE for communications with the second network function using the first access, and adjusting a connection between the UE and the second network function that uses the second access based on the rules, the indication of an availability of the UE, or both.

A second network function for wireless communications is described. The second network function may include one or more memories storing processor executable code, and one or more processors coupled with the one or more memories. The one or more processors may individually or collectively be operable to execute the code to cause the second network function to receive, from a first network function of the first network, an indication of rules for communications between a UE and the second network function using a second access if a first access is unavailable, transmit, to the first network function, an indication of UE activity using the first access, receive, from the first network function, an indication of an availability of the UE for communications with the second network function using the first access, and adjust a connection between the UE and the second network function that uses the second access based on the rules, the indication of an availability of the UE, or both.

Another second network function for wireless communications is described. The second network function may include means for receiving, from a first network function of the first network, an indication of rules for communications between a UE and the second network function using a second access if a first access is unavailable, means for transmitting, to the first network function, an indication of UE activity using the first access, means for receiving, from the first network function, an indication of an availability of the UE for communications with the second network function using the first access, and means for adjusting a connection between the UE and the second network function that uses the second access based on the rules, the indication of an availability of the UE, or both.

A non-transitory computer-readable medium storing code for wireless communications is described. The code may include instructions executable by one or more processors to receive, from a first network function of the first network, an indication of rules for communications between a UE and the second network function using a second access if a first access is unavailable, transmit, to the first network function, an indication of UE activity using the first access, receive, from the first network function, an indication of an availability of the UE for communications with the second network function using the first access, and adjust a connection between the UE and the second network function that uses the second access based on the rules, the indication of an availability of the UE, or both.

Some examples of the method, second network functions, and non-transitory computer-readable medium described herein may further include operations, features, means, or instructions for transmitting, to the first network function, an indication of UE activity using the first access in accordance with the rules and receiving, from the first network function and based on transmitting the indication of UE activity, an indication of an availability of the UE for communications with the second network function over the first access.

In some examples of the method, second network functions, and non-transitory computer-readable medium described herein, adjusting the connection may include operations, features, means, or instructions for terminating the connection immediately upon receiving the indication of an availability of the UE over the first access, terminating the connection in accordance with a duration upon receiving the indication of an availability of the UE over the first access, and maintaining the connection.

In some examples of the method, second network functions, and non-transitory computer-readable medium described herein, the first network function may be an SMF and the second network function may be a UPF.

In some examples of the method, second network functions, and non-transitory computer-readable medium described herein, the first access may be integrated in a first network and the second access may be non-integrated in the first network, and where the first network may be a 3GPP network.

In some examples of the method, second network functions, and non-transitory computer-readable medium described herein, the first access may be a 3GPP access and the second access may be a non-integrated non-3GPP access.

In some examples of the method, second network functions, and non-transitory computer-readable medium described herein, the connection may be an MPQUIC connection or an MPTCP connection.

A method for wireless communications by a UE is described. The method may include transmitting, to a first network function of a first network and via a first access, a request to establish a PDU session for communications between the UE and a second network function, the request including a request to establish a connection with the second network function using only a second access different from the first access, receiving an indication of rules for communicating with the second network function using only the second access, establishing a connection with a second network function via the second access, transmitting, to the first network function and via the first access, a request to release one or more first resources for the PDU session, the one or more first resources associated with the first access, communicating with the second network function via only the second access in accordance with the indication of rules, and releasing one or more second resources for the PDU session based on an expiration of a timer, the one or more second resources associated with the second access.

A UE for wireless communications is described. The UE may include one or more memories storing processor executable code, and one or more processors coupled with the one or more memories. The one or more processors may individually or collectively be operable to execute the code to cause the UE to transmit, to a first network function of a first network and via a first access, a request to establish a PDU session for communications between the UE and a second network function, the request including a request to establish a connection with the second network function using only a second access different from the first access, receive an indication of rules for communicating with the second network function using only the second access, establish a connection with a second network function via the second access, transmit, to the first network function and via the first access, a request to release one or more first resources for the PDU session, the one or more first resources associated with the first access, communicate with the second network function via only the second access in accordance with the indication of rules, and release one or more second resources for the PDU session based on an expiration of a timer, the one or more second resources associated with the second access.

Another UE for wireless communications is described. The UE may include means for transmitting, to a first network function of a first network and via a first access, a request to establish a PDU session for communications between the UE and a second network function, the request including a request to establish a connection with the second network function using only a second access different from the first access, means for receiving an indication of rules for communicating with the second network function using only the second access, means for establishing a connection with a second network function via the second access, means for transmitting, to the first network function and via the first access, a request to release one or more first resources for the PDU session, the one or more first resources associated with the first access, means for communicating with the second network function via only the second access in accordance with the indication of rules, and means for releasing one or more second resources for the PDU session based on an expiration of a timer, the one or more second resources associated with the second access.

A non-transitory computer-readable medium storing code for wireless communications is described. The code may include instructions executable by one or more processors to transmit, to a first network function of a first network and via a first access, a request to establish a PDU session for communications between the UE and a second network function, the request including a request to establish a connection with the second network function using only a second access different from the first access, receive an indication of rules for communicating with the second network function using only the second access, establish a connection with a second network function via the second access, transmit, to the first network function and via the first access, a request to release one or more first resources for the PDU session, the one or more first resources associated with the first access, communicate with the second network function via only the second access in accordance with the indication of rules, and release one or more second resources for the PDU session based on an expiration of a timer, the one or more second resources associated with the second access.

Some examples of the method, UEs, and non-transitory computer-readable medium described herein may further include operations, features, means, or instructions for receiving an indication of rules for establishing the PDU session for communications between the UE and the second network function using only the second access, where the rules include extended UE route selection policy (URSP) rules.

Some examples of the method, UEs, and non-transitory computer-readable medium described herein may further include operations, features, means, or instructions for transmitting, to the first network function, a request to terminate the connection of the PDU session.

Some examples of the method, UEs, and non-transitory computer-readable medium described herein may further include operations, features, means, or instructions for transmitting, to the first network function via the first access and prior to the expiration of the timer, a request to refresh the timer and receiving a second indication of rules, the second indication including a refreshed timer.

In some examples of the method, UEs, and non-transitory computer-readable medium described herein, the UE transmits the request via a PDU session modification request message.

Some examples of the method, UEs, and non-transitory computer-readable medium described herein may further include operations, features, means, or instructions for transmitting the request further includes, transmitting the request using a dedicated data network name (DNN).

In some examples of the method, UEs, and non-transitory computer-readable medium described herein, the UE communicates with the second network function in accordance with the timer, where the timer may be predefined.

In some examples of the method, UEs, and non-transitory computer-readable medium described herein, the first network function may be an SMF and the second network function may be a UPF.

In some examples of the method, UEs, and non-transitory computer-readable medium described herein, the first access may be integrated in the first network and the second access may be non-integrated in the first network, and where the first network may be a 3GPP network.

In some examples of the method, UEs, and non-transitory computer-readable medium described herein, the first access may be a 3GPP access and the second access may be a non-integrated non-3GPP access.

In some examples of the method, UEs, and non-transitory computer-readable medium described herein, the connection may be an MPQUIC connection or an MPTCP connection.

A method for wireless communications by a first network function is described. The method may include receiving an indication of rules for communications with a second network function using a first access and using a second access different from the first access, establishing a PDU session for communications between a UE and a second network function based on receiving a request to establish the PDU session, the request including a request to establish a connection with the second network function using only a second access, transmitting an indication of a first set of rules for communications between the UE and the second network function using only the second access to the UE and transmitting an indication of a second set of rules for communications between the UE and the second network function using only the second access to the second network function, and releasing one or more first resources for the PDU session based on receiving, from the UE and via the first access, a request to release the one or more first resources, the one or more first resources associated with the first access.

A first network function for wireless communications is described. The first network function may include one or more memories storing processor executable code, and one or more processors coupled with the one or more memories. The one or more processors may individually or collectively be operable to execute the code to cause the first network function to receive an indication of rules for communications with a second network function using a first access and using a second access different from the first access, establish a PDU session for communications between a UE and a second network function based on receiving a request to establish the PDU session, the request including a request to establish a connection with the second network function using only a second access, transmit an indication of a first set of rules for communications between the UE and the second network function using only the second access to the UE and transmitting an indication of a second set of rules for communications between the UE and the second network function using only the second access to the second network function, and release one or more first resources for the PDU session based on receiving, from the UE and via the first access, a request to release the one or more first resources, the one or more first resources associated with the first access.

Another first network function for wireless communications is described. The first network function may include means for receiving an indication of rules for communications with a second network function using a first access and using a second access different from the first access, means for establishing a PDU session for communications between a UE and a second network function based on receiving a request to establish the PDU session, the request including a request to establish a connection with the second network function using only a second access, means for transmitting an indication of a first set of rules for communications between the UE and the second network function using only the second access to the UE and transmitting an indication of a second set of rules for communications between the UE and the second network function using only the second access to the second network function, and means for releasing one or more first resources for the PDU session based on receiving, from the UE and via the first access, a request to release the one or more first resources, the one or more first resources associated with the first access.

A non-transitory computer-readable medium storing code for wireless communications is described. The code may include instructions executable by one or more processors to receive an indication of rules for communications with a second network function using a first access and using a second access different from the first access, establish a PDU session for communications between a UE and a second network function based on receiving a request to establish the PDU session, the request including a request to establish a connection with the second network function using only a second access, transmit an indication of a first set of rules for communications between the UE and the second network function using only the second access to the UE and transmitting an indication of a second set of rules for communications between the UE and the second network function using only the second access to the second network function, and release one or more first resources for the PDU session based on receiving, from the UE and via the first access, a request to release the one or more first resources, the one or more first resources associated with the first access.

Some examples of the method, first network functions, and non-transitory computer-readable medium described herein may further include operations, features, means, or instructions for receiving, from UE and via the first access, a request to refresh a timer associated with communications between the UE and the second network function via the second access.

In some examples of the method, first network functions, and non-transitory computer-readable medium described herein, the first set of rules include extended ATSSS rules and where the second set of rules include extended N4 rules.

Some examples of the method, first network functions, and non-transitory computer-readable medium described herein may further include operations, features, means, or instructions for transmitting, to the second network function, an indication to terminate a connection between the UE and the second network function that uses the second access based on one or more local policies at the first network function, a timer associated with communications between the UE and the second network function via the second access, or both.

Some examples of the method, first network functions, and non-transitory computer-readable medium described herein may further include operations, features, means, or instructions for transmitting, to the UE and prior to an expiration of a timer associated with communications between the UE and the second network function via the second access, a protocol data unit session release message indicating that the PDU session may be terminated.

In some examples of the method, first network functions, and non-transitory computer-readable medium described herein, the first network function may be an SMF and the second network function may be a UPF.

In some examples of the method, first network functions, and non-transitory computer-readable medium described herein, the first access may be integrated in a first network and the second access may be non-integrated in the first network, and where the first network may be a 3GPP network.

In some examples of the method, first network functions, and non-transitory computer-readable medium described herein, the first access may be a 3GPP access and the second access may be a non-integrated non-3GPP access.

A method for wireless communications by a second network function is described. The method may include receiving, from a first network function in communications with a UE via a first access and a second access, an indication of rules for communications between the UE and the second network function using only the second access and using a PDU session, communicating with the UE via a connection via only the second access in accordance with the indication of rules, and releasing one or more resources for the PDU session based on an expiration of a timer, the one or more resources associated with the second access.

A second network function for wireless communications is described. The second network function may include one or more memories storing processor executable code, and one or more processors coupled with the one or more memories. The one or more processors may individually or collectively be operable to execute the code to cause the second network function to receive, from a first network function in communications with a UE via a first access and a second access, an indication of rules for communications between the UE and the second network function using only the second access and using a PDU session, communicate with the UE via a connection via only the second access in accordance with the indication of rules, and release one or more resources for the PDU session based on an expiration of a timer, the one or more resources associated with the second access.

Another second network function for wireless communications is described. The second network function may include means for receiving, from a first network function in communications with a UE via a first access and a second access, an indication of rules for communications between the UE and the second network function using only the second access and using a PDU session, means for communicating with the UE via a connection via only the second access in accordance with the indication of rules, and means for releasing one or more resources for the PDU session based on an expiration of a timer, the one or more resources associated with the second access.

A non-transitory computer-readable medium storing code for wireless communications is described. The code may include instructions executable by one or more processors to receive, from a first network function in communications with a UE via a first access and a second access, an indication of rules for communications between the UE and the second network function using only the second access and using a PDU session, communicate with the UE via a connection via only the second access in accordance with the indication of rules, and release one or more resources for the PDU session based on an expiration of a timer, the one or more resources associated with the second access.

Some examples of the method, second network functions, and non-transitory computer-readable medium described herein may further include operations, features, means, or instructions for transmitting, to the first network function, an indication that the one or more resources for the PDU session may have been released.

Some examples of the method, second network functions, and non-transitory computer-readable medium described herein may further include operations, features, means, or instructions for terminating the connection over the second access based on receiving an indication from the first network function to terminate the connection.

In some examples of the method, second network functions, and non-transitory computer-readable medium described herein, the first network function may be an SMF and the second network function may be a UPF.

In some examples of the method, second network functions, and non-transitory computer-readable medium described herein, the second access may be non-integrated in a first network, and where the first network may be a 3GPP network.

In some examples of the method, second network functions, and non-transitory computer-readable medium described herein, the second access may be a non-integrated non-3GPP access.

In some examples of the method, second network functions, and non-transitory computer-readable medium described herein, the connection may be an MPQUIC connection or an MPTCP connection.

### BRIEF DESCRIPTION OF THE DRAWINGS

FIG. 1 shows an example of a wireless communications system that supports protocol data unit sessions using a non-integrated access in accordance with one or more aspects of the present disclosure.

FIG. 2 shows an example of a wireless communications system that supports protocol data unit sessions using a non-integrated access in accordance with one or more aspects of the present disclosure.

FIG. 3 shows an example of a process flow that supports protocol data unit sessions using a non-integrated access in accordance with one or more aspects of the present disclosure.

FIG. 4 shows an example of a process flow that supports protocol data unit sessions using a non-integrated access in accordance with one or more aspects of the present disclosure.

FIG. 5 shows an example of a process flow that supports protocol data unit sessions using a non-integrated access in accordance with one or more aspects of the present disclosure.

FIG. 6 shows an example of a process flow that supports protocol data unit sessions using a non-integrated access in accordance with one or more aspects of the present disclosure.

FIGS. 7 and 8 show block diagrams of devices that support protocol data unit sessions using a non-integrated access in accordance with one or more aspects of the present disclosure.

FIG. 9 shows a block diagram of a communications manager that supports protocol data unit sessions using a non-integrated access in accordance with one or more aspects of the present disclosure.

FIG. 10 shows a diagram of a system including a device that supports protocol data unit sessions using a non-integrated access in accordance with one or more aspects of the present disclosure.

FIGS. 11 and 12 show block diagrams of devices that support protocol data unit sessions using a non-integrated access in accordance with one or more aspects of the present disclosure.

FIG. 13 shows a block diagram of a communications manager that supports protocol data unit sessions using a non-integrated access in accordance with one or more aspects of the present disclosure.

FIG. 14 shows a diagram of a system including a device that supports protocol data unit sessions using a non-integrated access in accordance with one or more aspects of the present disclosure.

FIGS. 15 and 16 show block diagrams of devices that support protocol data unit sessions using a non-integrated access in accordance with one or more aspects of the present disclosure.

FIG. 17 shows a block diagram of a communications manager that supports protocol data unit sessions using a non-integrated access in accordance with one or more aspects of the present disclosure.

FIG. 18 shows a diagram of a system including a device that supports protocol data unit sessions using a non-integrated access in accordance with one or more aspects of the present disclosure.

FIGS. 19 through 27 show flowcharts illustrating methods that support protocol data unit sessions using a non-integrated access in accordance with one or more aspects of the present disclosure.

### DETAILED DESCRIPTION

In some wireless communications systems, a user equipment (UE) may communicate with a core network via first access and a second access. In some cases, the second access may be a non-integrated access. For example, the UE may communicate with the core network via a Third-Generation Partnership Program (3GPP) network over a 3GPP access (3GPPA) and a non-3GPP network over a non-integrated non-3GPP access (NIN3A). The UE may establish a protocol data unit (PDU) session with the core network to communicate data via the 3GPPA and the NIN3A. However, in some cases, the UE may become unreachable over the 3GPPA (e.g., may be out of 3GPP coverage) while still connected to the core network over the NIN3A. Alternatively, the UE may indicate a preference to communicate with the core network over the NIN3A, even if the 3GPPA is available.

Various aspects of the present disclosure relate to protocol data unit sessions using a non-integrated access when an integrated access is unavailable or unused. In some examples, a UE and a session management function (SMF) of a first network (e.g., a 3GPP network) may receive rules for establishing a PDU session for communicating with a user plane function (UPF) of the 3GPP network over a first access (e.g., a 3GPPA) and a second access (e.g., an NIN3A). The UE may request establishment of the PDU session, and the SMF may establish the PDU session. The SMF may also indicate rules for communicating with the UPF via the NIN3A if the 3GPPA is unavailable at the UE to the UE and to the UPF of the 3GPP network. The UE may establish a first connection with the UPF over the 3GPPA and a second connection with the UPF over the NIN3A. If the UE becomes unreachable via the 3GPPA, the SMF may transmit an indication of UE unavailability to the UPF, and the UPF may adjust the second connection. For example, the UPF may terminate the second connection immediately or after a duration, or may maintain the second connection indefinitely. Alternatively, the UE may adjust the second connection based on the expiration of a timer.

In some other examples, the UE and the SMF may receive rules for establishing a PDU session for communicating with the UPF over the NIN3A only. The UE may request establishment of the PDU session, and the SMF may establish the PDU session. The SMF may also indicate rules for communicating with the core network via the NIN3A only to the UE and to the UPF. The UE may establish a connection with the UPF over the NIN3A. The UE may request for the SMF to release 3GPPA resources for the PDU session and may communicate data with the UPF via the connection. Upon expiration of a timer, the UE and the UPF may release NIN3A resources for the PDU session.

Aspects of the disclosure are initially described in the context of wireless communications systems. Aspects of the disclosure are additionally illustrated by and described with reference to process flows. Aspects of the disclosure are further illustrated by and described with reference to apparatus diagrams, system diagrams, and flowcharts that relate to protocol data unit sessions using a non-integrated access.

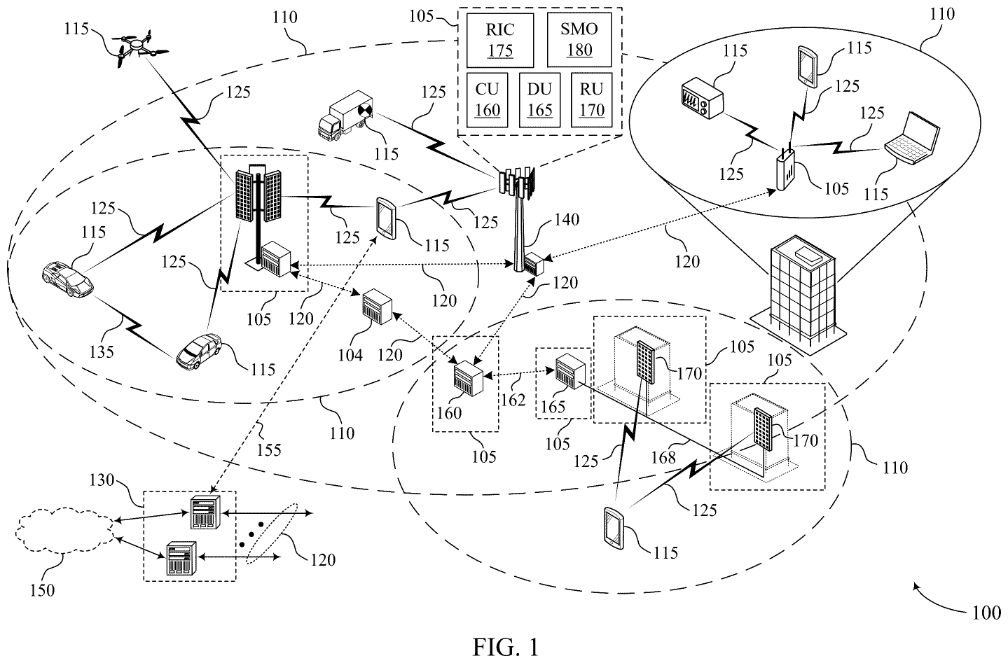

FIG. 1 shows an example of a wireless communications system 100 that supports protocol data unit sessions using a non-integrated access in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may request establishment of a PDU session for communicating with a UPF of a first network (e.g., a 3GPP network) over a first access (e.g., a 3GPPA) and a second access (e.g., an NIN3A). An SMF of the first network may establish the PDU session. During PDU session establishment, the SMF may indicate rules for communications between the UE 115 and the UPF over the NIN3A when the 3GPPA is unavailable at the UE 115 to both the UE 115 and the UPF. The UE 115 may establish a first connection with the UPF over the 3GPPA and a second connection with the UPF over the NIN3A. If the UE 115 becomes unreachable via the 3GPPA, the SMF may indicate to the UPF that the UE 115 is unavailable over the 3GPPA, and the UPF may adjust the second connection in accordance with the indicated rules. For example, the UPF may terminate the second connection immediately or after a duration, or may maintain the second connection indefinitely. Alternatively, the UE 115 may adjust the second connection in accordance with the rules based on the expiration of a timer.

In some other examples, the UE 115 may request establishment of a PDU session for communicating with the UPF over the NIN3A only. The SMF may establish the PDU session and indicate rules for communicating with the core network via the NIN3A only to both the UE 115 and to the UPF. The UE 115 may establish a connection with the UPF over the NIN3A. The UE 115 may request for the SMF to release 3GPPA resources of the PDU session and may communicate data with the UPF via the connection over NIN3A. Upon expiration of a timer, the UE 115 and the UPF may release NIN3A resources for the PDU session. Alternatively, before expiration of the timer, the UE 115 may request a timer refresh from the SMF.

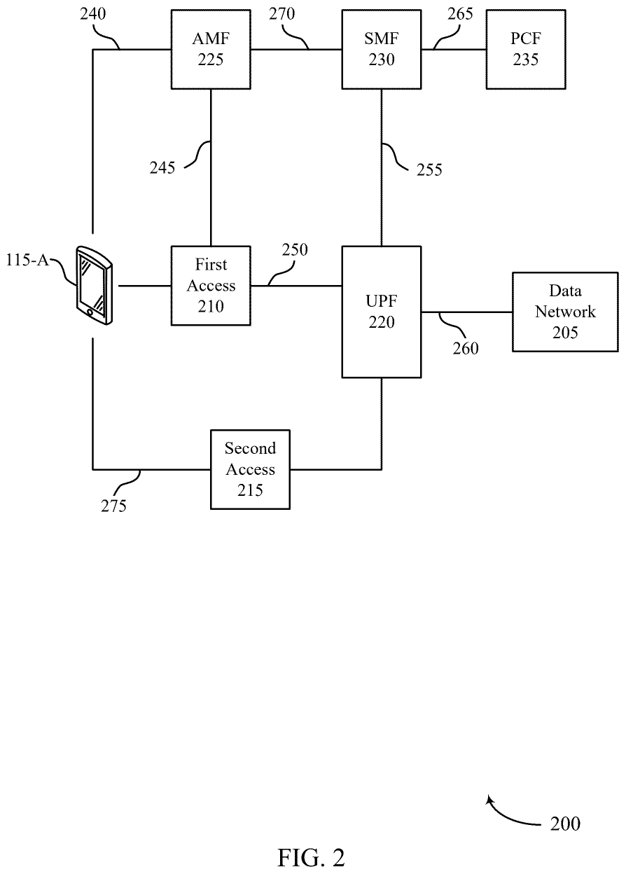

FIG. 2 shows an example of a wireless communications system 200 that supports protocol data unit sessions using a non-integrated access in accordance with one or more aspects of the present disclosure. The wireless communications system 200 may include a UE 115-a, which may communicate with a data network 205. The data network 205 may be an example of a core network 130 as described with reference to FIG. 1. The UE 115-a may communicate with the data network 205 via a first access 210 and a second access 215.

In some examples, the first access may be integrated into a first network, which may be a home public land mobile network, such as a 3GPP network. In such examples, the first access 210 may be a 3GPP access (3GPPA). The second access 215 may be a non-3GPPA. Additionally, in some examples, the second access 215 may be non-integrated into the 3GPP network; that is, the second access may be a non-integrated, non-3GPP access (NIN3A). In such examples where the second access 215 is a non-integrated access, the UE 115-a may communicate network traffic with a UPF 220 via the second access 215 using the internet. The UE 115-a and the data network 205 may communicate control plane signaling, such as NAS signaling via the 3GPPA, and may not communicate NAS signaling via the NIN3A.

The 3GPP network may include multiple network functions. For example, the 3GPP network may include an AMF 225, an SMF 230, and a policy control function (PCF) 235. The UE 115-a may communicate with the AMF 225 via interface 240 (e.g., a 5G N1 interface). The AMF 225 may communicate with the first access 210 via interface 245 (e.g., a 5G N2 interface). The UE 115-a may communicate with the UPF 220 over the first access 210 via interface 250 (e.g., a 5G N3 interface). The SMF 230 may communicate with the UPF 220 via interface 255 (e.g., a 5G N4 interface). The UPF 220 may communicate with the data network 205 via interface 260 (e.g., a 5G N6 interface). The SMF 230 may communicate with the PCF 235 via interface 265 (e.g., a 5G N7 interface). The SMF 230 may communicate with the AMF 225 via interface 270 (e.g., a 5G N11 interface). Similarly, the UE 115-a may communicate with the UPF 220 over the second access 215 via interface 275 (e.g., a 5G interface).

The UE 115-a and the UPF 220 may communicate data via a PDU session established by the SMF 230 in accordance with one or more rules for communications between the UE 115-a and the UPF 220. In some examples, the PDU session may be a multi-access PDU (MA PDU) session. The SMF 230 may establish the PDU session in accordance with the one or more rules for communications between the UE 115-a and the UPF 220.

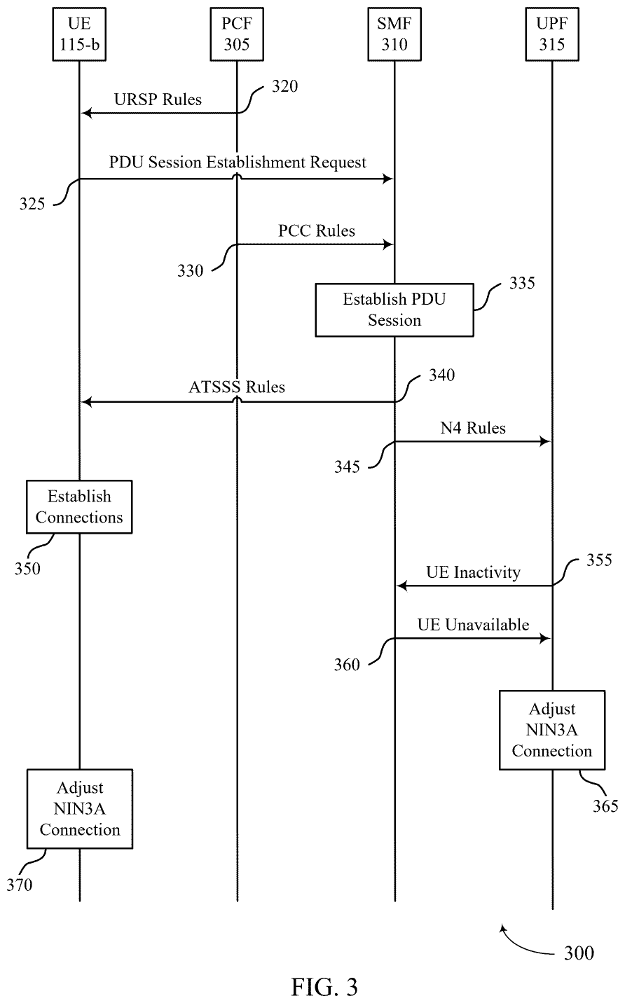

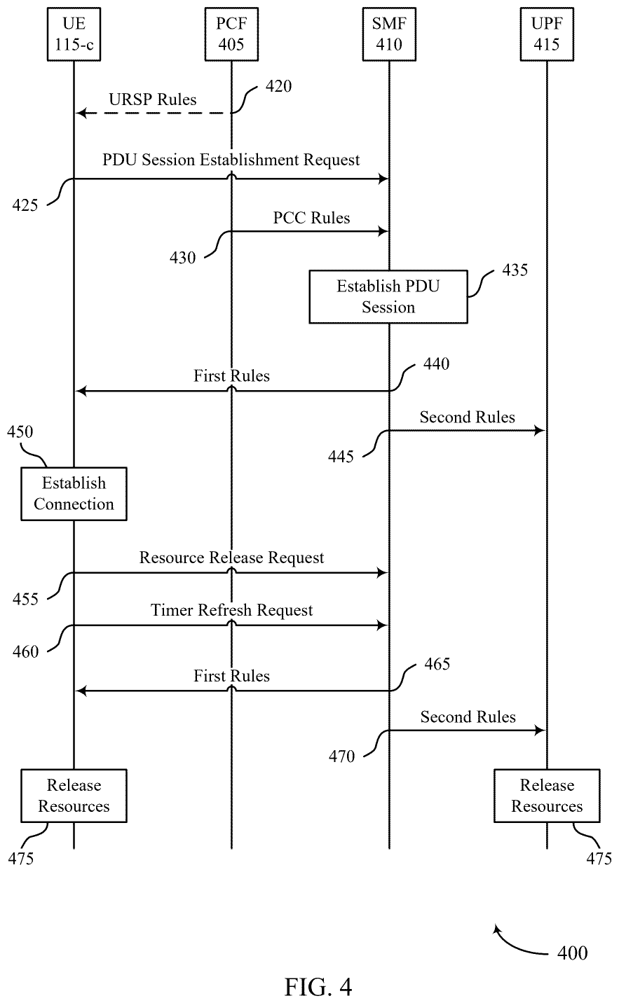

In some examples, the UE 115-a, the UPF 220, and the SMF 230 may implement rules to support communicating with the data network 205 via the second access 215 when the first access 210 is unavailable at the UE 115-a. Such examples are described in more detail herein with respect to FIG. 3. In some other examples, the UE 115-a, the UPF 220, and the SMF 230 may implement rules to support communicating with the data network 205 only via the second access 215. Such examples are described in more detail herein with respect to FIG. 4.

FIG. 3 shows an example of a process flow 300 that supports protocol data unit sessions using a non-integrated access in accordance with one or more aspects of the present disclosure. The process flow 300 may implement or be implemented by aspects of the wireless communications system 100 and the wireless communications system 200 as described with reference to FIGS. 1 and 2. For instance, in the example of FIG. 3, a UE 115-b may communicate with a PCF 305, an SMF 310, and a UPF 315, which may be examples of corresponding devices described herein, including with reference to FIG. 1 and FIG. 2. In the following description of the process flow 300, the operations between the UE 115-b, the PCF 305, the SMF 310, and the UPF 315 may be performed in a different order than the example shown, or the operations between the UE 115-b, the PCF 305, the SMF 310, and the UPF 315 may be performed in different orders at different times. Some operations may also be omitted form the process flow 300, and other operations may be added to the process flow 300.

The UE 115-b may communicate with a core network (not shown) via a first network, which may include one or more network functions, including the PCF 305, the SMF 310, and the UPF 315. Additionally, in some examples, the first network may also include an AMF (not shown). In some examples, the first network may be a 3GPP network. In the example of FIG. 3, the UE 115-b may be configured to communicate with the core network over a first access and over a second access. In such examples, the first access may be a 3GPPA, and the second access may be a non-3GPPA. For example, the first access may be an integrated access (e.g., integrated into the 3GPP network), and the second access may be a non-integrated access (e.g., an NIN3A). The UE 115-b may communicate data with the core network via a PDU session. In some examples, the PDU session may be an MA PDU session.

The UE 115-b may receive an indication of rules for establishing a PDU session for communications between the UE 115-b and the UPF 315 using the 3GPPA and the NIN3A. In some examples, the rules may include UE route selection policy (URSP) rules. For example, at 320, the UE 115-b may receive URSP rules from the PCF 305. In some cases, the UE 115-b may receive the URSP rules during UE registration with the first network.

The UE 115-b may transmit a request to establish the PDU session for communications between the UE 115-b and the UPF 315. For example, at 325, the UE 115-b may transmit a request to establish a PDU session using both the 3GPPA and the NIN3A. The UE 115-b may transmit the request via the 3GPPA. In some examples, the UE 115-b may transmit the request directly to the SMF 310. In some other examples, the UE 115-b may transmit the request to an AMF of the 3GPP network, and the AMF may transmit the request to the SMF 310.

The SMF 310 may receive an indication of rules for establishing the PDU session for communications between the UE 115-b and the UPF 315 using the 3GPPA and the NIN3A. In some examples, the rules may include policy and charging control (PCC) rules. For example, at 330, the SMF 310 may receive PCC rules from the PCF 305. The PCC rules may include rules for communications between the UE 115-b and the UPF 315 using the NIN3A when the 3GPPA is unavailable.

At 335, the SMF 310 may establish the PDU session based on receiving the request to establish the PDU session. For example, the SMF 310 may allocate a PDU session identifier (ID) for the PDU session via the 3GPPA. During PDU establishment, the SMF 310 may transmit an indication of rules for communications between the UE 115-b and the UPF 315 using the NIN3A when the 3GPPA is unavailable. For example, at 340, the SMF 310 may transmit access traffic steering, switching, and splitting (ATSSS) rules to the UE 115-b indicating rules for communications between the UE 115-b and the UPF 315 using the NIN3A when the 3GPPA is unavailable. Similarly, at 345, the SMF 310 may transmit N4 rules to the UPF 315 indicating rules for communications between the UE 115-b and the UPF 315 using the NIN3A when the 3GPPA is unavailable. In some examples, the rules for communications between the UE 115-b and the UPF 315 using the NIN3A when the 3GPPA is unavailable may indicate for the UE 115-b and the UPF 315 to release the NIN3A together with the 3GPPA, may indicate to release the NIN3A after waiting for an additional amount of time, or may indicate to maintain the NIN3A indefinitely.

Additionally, during PDU session establishment, the SMF 310 may indicate connection information to the UE 115-b. In some examples, the connection information may include an IP address of the UPF 315, a port number of the UPF 315, security materials (e.g., a security certificate) for a multipath QUIC (MPQUIC) connection between the UE 115-b and the UPF 315, to the UE 115-b, security materials for transport layer security, or any combination thereof, to the UE 115-b. The UE 115-b may establish connections with the UPF 315 based on the connection information. The SMF 310 may include the connection information in the ATSSS rules.

The UE 115-b may establish connections with the UPF 315 over the NIN3A and the 3GPPA. For example, at 350, the UE 115-b may establish a first MPQUIC connection with the UPF 315 over the 3GPPA and may establish a second MPQUIC connection with the UPF 315 over the NIN3A. Alternatively, the UE 115-b may establish a first multipath transmission control protocol (MPTCP) connection with the UPF 315 over the 3GPPA and may establish a second MPTCP connection with the UPF 315 over the NIN3A. The UE 115-b may establish the connections with the UPF 315 based on the connection information.

In some examples, the UE 115-b may become unreachable over the 3GPPA at some point (e.g., in time) after establishing the connections with the UPF 315, which may cause inactivity of the UE 115-b over the 3GPPA. For example, the UE 115-b may exit a coverage area associated with the 3GPPA. In such examples, the UPF 315 may transmit an indication of activity of the UE 115-b over the 3GPPA to the SMF 310. For example, at 355, the UPF 315 may indicate to the SMF 310 that the UE 115-b is inactive over the 3GPPA. The UPF 315 may transmit the indication based on, or in accordance with, the N4 rules transmitted to the UPF 315 by the SMF 310.

At 360, the SMF 310 may transmit an indication of an availability of the UE 115-b over the 3GPPA to the UPF 315. For example, the SMF 310 may indicate that the UE 115-b is unavailable via the 3GPPA (e.g., is not reachable via the 3GPPA). The SMF 310 may transmit the indication based on receiving signaling from a network function. For example, the SMF 310 may transmit the indication based on receiving the indication of activity of the UE 115-b from the UPF 315. Additionally, or alternatively, the SMF 310 may transmit the indication based on receiving signaling from an AMF (not shown) indicating that the UE 115-b is not reachable over the 3GPPA upon expiration of a periodic registration timer. In such examples, the SMF 310 may maintain (e.g., keep) the PDU session ID for the PDU session. In such examples where the UE 115-b becomes unreachable over the 3GPPA, the PDU session may continue (e.g., may not be terminated) and may be associated with the second MPQUIC connection.

At 365, the UPF 315 may adjust the second MPQUIC connection. The UPF 315 may adjust the second MPQUIC connection based on, or in accordance with, the N4 rules transmitted to the UPF 315 by the SMF 310. Additionally, or alternatively, the UPF 315 may adjust the second MPQUIC connection based on receiving the indication of the availability of the UE 115-b over the 3GPPA from the SMF 310. For example, to adjust the second MPQUIC connection, the UPF 315 may terminate the second MPQUIC connection immediately, may terminate the second MPQUIC connection after a duration has elapsed, or may maintain the second MPQUIC connection indefinitely.

Similarly, at 370, the UE 115-b may adjust the second MPQUIC connection. The UE 115-b may adjust the second MPQUIC connection based on, or in accordance with, the ATSSS rules transmitted to the UE 115-b by the SMF 310. Additionally, or alternatively, the UE 115-b may adjust the second MPQUIC connection based on the expiration of a timer at the UE 115-b. The timer may be a 3GPPA session timer. In some examples, to adjust the second MPQUIC connection, the UPF 315 may determine to terminate the second MPQUIC connection immediately, may determine to terminate the second MPQUIC connection after a duration has elapsed, or may determine to maintain the second MPQUIC connection indefinitely.

In some examples, the UE 115-b may become available over the 3GPPA before the NIN3A is released (e.g., terminated). For example, the UE 115-b may reenter the coverage area associated with the 3GPPA. In such examples, the UE 115-b may transmit a service request message to reestablish the first MPQUIC connection with the UPF 315 over the 3GPPA. The UE 115-b may also transmit a PDU session modification message to reestablish the first MPQUIC connection. The UE 115-b and the UPF 315 may continue to communicate in accordance with the ATSSS rules and the N4 rules indicated by the SMF 310, respectively.

FIG. 4 shows an example of a process flow 400 that supports protocol data unit sessions using a non-integrated access in accordance with one or more aspects of the present disclosure. The process flow 400 may implement or be implemented by aspects of the wireless communications system 100 and the wireless communications system 200 as described with reference to FIGS. 1 and 2. For instance, in the example of FIG. 4, a UE 115-c may communicate with a PCF 405, an SMF 410, and a UPF 415, which may be examples of corresponding devices described herein, including with reference to FIG. 1 and FIG. 2. In the following description of the process flow 400, the operations between the UE 115-c, the PCF 405, the SMF 410, and the UPF 415 may be performed in a different order than the example shown, or the operations between the UE 115-c, the PCF 405, the SMF 410, and the UPF 415 may be performed in different orders at different times. Some operations may also be omitted form the process flow 400, and other operations may be added to the process flow 400.

The UE 115-c may communicate with a core network (not shown) via a first network, which may include one or more network functions, including the PCF 405, the SMF 410, and the UPF 415. Additionally, in some examples, the first network may also include an AMF (not shown). In some examples, the first network may be a 3GPP network. In the example of FIG. 4, the UE 115-c may be capable of communicating with the core network over a first access and over a second access, but may be configured to communicate with the core network over only the second access. In such examples, the first access may be a 3GPPA, and the second access may be a non-3GPPA. For example, the first access may be an integrated access (e.g., integrated into the 3GPP network), and the second access may be a non-integrated access (e.g., an NIN3A). The UE 115-c may communicate data with the core network via a PDU session. In some examples, the PDU session may be an MA PDU session.

In some examples, the UE 115-c may receive an indication of rules for establishing a PDU session for communications between the UE 115-c and the UPF 415 only using the second access (e.g., NIN3A). In such examples, the rules may include URSP rules. The UE 115-c may receive the URSP rules during UE registration with the first network. For example, at 420, the UE 115-c may receive URSP rules from the PCF 405. In some examples, a bit field of the URSP rules that indicates a type for the PDU session may be extended to include a new bit sequence that indicates a PDU session only using the NIN3A. For example, the URSP rules may be extended to indicate for the UE 115-c to communicate with the UPF 415 via a PDU session only using the NIN3A. In such examples, network traffic may be transferred over the NIN3A, and the UE 115-c may request for the SMF 410 to terminate a connection of the PDU session that uses the 3GPPA.

The UE 115-c may transmit a request to establish the NIN3A-only PDU session for communications between the UE 115-c and the UPF 415. For example, at 425, the UE 115-c may transmit the request to establish the NIN3A-only PDU session only using the NIN3A via the 3GPPA. In some examples, the UE 115-c may transmit the request directly to the SMF 410. In some other examples, the UE 115-c may transmit the request to an AMF of the 3GPP network, and the AMF may transmit the request to the SMF 410. In some examples where the UE 115-c receives the URSP rules from the PCF 405, the UE 115-c may transmit the request using a dedicated data network name (DNN). In some other examples where the UE 115-c does not receive the URSP rules from the PCF 405, the UE 115-c may not transmit the request using a dedicated DNN.

The SMF 410 may receive an indication of rules for establishing the PDU session for communications between the UE 115-c and the UPF 415 only using the NIN3A (e.g., an NIN3A-only PDU session). In some examples, the rules may include PCC rules. For example, at 430, the SMF 410 may receive PCC rules from the PCF 405. The PCC rules may include rules for communications between the UE 115-c and the UPF 415 using the NIN3A when the 3GPPA is unavailable.

At 435, the SMF 410 may establish the NIN3A-only PDU session based on receiving the request to establish the NIN3A-only PDU session. For example, the SMF 410 may allocate a PDU session ID for the NIN3A-only PDU session via the first access. During PDU establishment, the SMF 410 may transmit an indication of rules for communications between the UE 115-c and the UPF 415 only using the NIN3A. For example, at 440, the SMF 410 may transmit a first indication of rules to the UE 115-c indicating rules for communications between the UE 115-c and the UPF 415 only using the NIN3A. Similarly, at 445, the SMF 410 may transmit a second indication of rules to the UPF 415 indicating rules for communications between the UE 115-c and the UPF 415 only using the NIN3A.

In some examples, the rules for communications between the UE 115-c and the UPF 415 only using the NIN3A may indicate for the UE 115-c and the UPF 415 to release the NIN3A together with the 3GPPA, may indicate to release the NIN3A after waiting for a predefined amount of time, or may indicate to maintain the NIN3A indefinitely. The predefined amount of time may be preconfigured at the UE 115-c, the UPF 415, or both, or may be indicated to the UE 115-c, the UPF 415, or both, by the SMF 410.

In some examples where the UE does not receive the URSP rules from the PCF 405, the SMF 410 may indicate the rules for communications between the UE 115-c and the UPF 415 only using the NIN3A via ATSSS rules and via N4 rules. For example, at 440, the SMF 410 may transmit ATSSS rules to the UE 115-c including the first indication of rules. Similarly, at 445, the SMF 410 may transmit N4 rules to the UPF 415 including the second indication of rules.

In some examples, the ATSSS rules, the N4 rules, or both, may be extended to include a new bit sequence that indicates rules for communications between the UE 115-c and the UPF 415 only using the NIN3A. In the example of FIG. 4, the ATSSS rules, the N4 rules, or both may be extended to include an explicit indication for the UE 115-c to communicate with the UPF 415 via the NIN3A-only PDU session. Additionally, the ATSSS rules, the N4 rules, or both may be extended to indicate a new steering mode associated with the NIN3A-only PDU session, a new code point for active standby behavior for the NIN3A-only PDU session, a new code point for load balancing behavior for the NIN3A-only PDU session, or any combination thereof.

Additionally, during PDU session establishment, the SMF 410 may indicate connection information to the UE 115-c. In some examples, the connection information may include an IP address of the UPF 415, a port number of the UPF 415, security materials (e.g., a security certificate) for a multipath QUIC (MPQUIC) connection between the UE 115-c and the UPF 415, to the UE 115-c, security materials for transport layer security, or any combination thereof, to the UE 115-c. The UE 115-c may establish connections with the UPF 415 based on the connection information.

The UE 115-c may establish a connection with the UPF 415 over the NIN3A. For example, at 450, the UE 115-c may establish an MPQUIC connection with the UPF 415 over the NIN3A. Alternatively, the UE 115-c may establish an MPTCP connection with the UPF 415 over the NIN3A. The UE 115-c may establish the connections with the UPF 415 based on the connection information.

The UE 115-c may request a resource release from the SMF 410. For example, at 455, the UE 115-c may transmit a request to the SMF 410 to release a first set of resources of the NIN3A-only PDU session associated with the 3GPPA. The UE 115-c may transmit the request via the 3GPPA. The SMF 410 may release the 3GPPA resources for the NIN3A-only PDU session. In some examples where the SMF 410 releases the 3GPPA resources for the NIN3A-only PDU session, the resource release may not release UE context in the SMF 410 and the UPF 415. That is, the SMF 410 and the UPF 415 may still be aware of the UE 115-c after releasing the 3GPPA resources for the NIN3A-only PDU session.

The UE 115-c and the UPF 415 may communicate data via the connection over the NIN3A. In some examples, the UE 115-c and the UPF 415 may maintain the connection over the NIN3A for a predefined amount of time. For example, the UE 115-c and the UPF 415 may maintain the connection over the NIN3A in accordance with a timer (e.g., a PDU session timer). In some examples, prior to expiration of the timer, the UE 115-c may transmit a request to the SMF 410 to refresh the timer. For example, at 460, the UE 115-c may transmit a PDU session modification message to the SMF 410 via the 3GPPA to request a timer refresh from the SMF 410.

The SMF 410 may refresh the timer based on receiving the PDU session modification message from the UE 115-c. In some examples, the SMF 410 may retransmit the rules for communications between the UE 115-c and the UPF 415 only using the NIN3A to refresh the timer. For example, at 465, the SMF 410 may retransmit the first indication of rules to the UE 115-c indicating rules for communications between the UE 115-c and the UPF 415 only using the NIN3A. Similarly, at 470, the SMF 410 may retransmit the second indication of rules to the UPF 415 indicating rules for communications between the UE 115-c and the UPF 415 only using the NIN3A.

In some examples where the UE does not receive the URSP rules from the PCF 405, the SMF 410 may indicate the rules for communications between the UE 115-c and the UPF 415 only using the NIN3A via ATSSS rules and via N4 rules. For example, at 465, the SMF 410 may retransmit the ATSSS rules to the UE 115-c including the first indication of rules. Similarly, at 470, the SMF 410 may retransmit the N4 rules to the UPF 415 including the second indication of rules.

Upon expiration of the timer, the UE 115-c and the UPF 415 may release a second set of resources of the NIN3A-only PDU session associated with the NIN3A. For example, at 475, the UE 115-c and the UPF 415 may release the NIN3A resources for the NIN3A-only PDU session. In some examples where the 3GPPA is available at the UE 115-c, the UE 115-c may trigger PDU session release. In some other examples where the 3GPPA is not available at the UE 115-c, the UE 115-c and the UPF 415 may release the NIN3A resources locally. In such examples, the UPF 415 may transmit signaling to the SMF 410 indicating that the NIN3A resources are released.

In some examples, the UPF 415 may terminate the MPQUIC connection with the UE 115-c over the NIN3A prior to expiration of the timer. In such examples, the SMF 410 may instruct the UPF 415 to terminate the MPQUIC connection over the NIN3A based on one or more local policies at the SMF 410 or based on a timer at the SMF 410 associated with the NIN3A connection.

In some examples, the SMF 410 may notify the UE 115-c that the MPQUIC connection with the UPF 415 over the NIN3A is terminated by transmitting a PDU session release message. In such examples, the UE 115-c may transmit NAS signaling to the SMF 410. In some other examples, the UPF 415 may terminate the MPQUIC connection with the UE 115-c over the NIN3A, and the UE 115-c may locally release the NIN3A resources. In such examples, the UE 115-c may not transmit NAS signaling to the SMF 410.

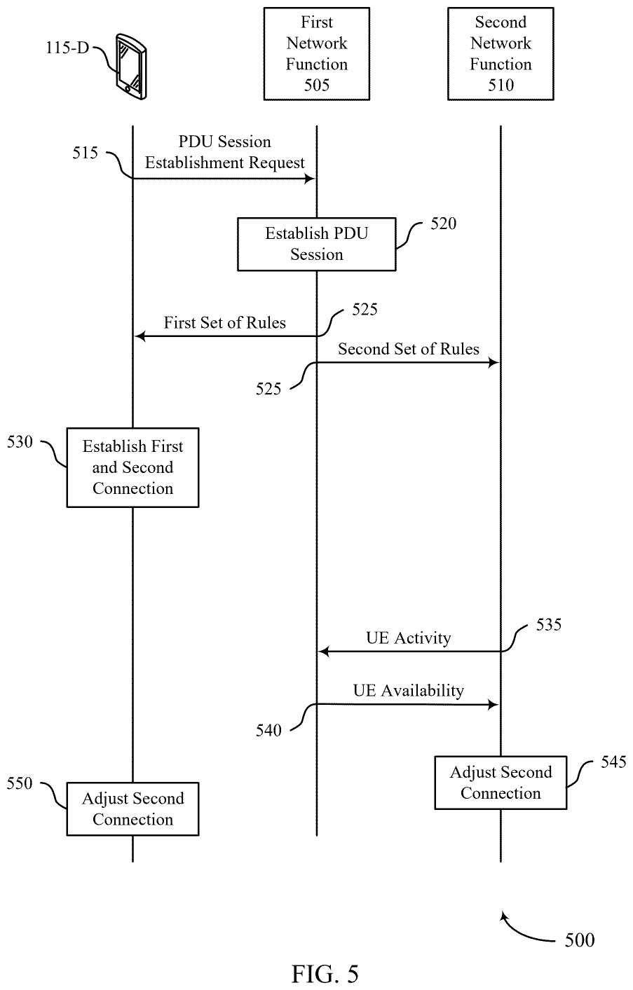

FIG. 5 shows an example of a process flow 500 that supports protocol data unit sessions using a non-integrated access in accordance with one or more aspects of the present disclosure. The process flow 500 may implement or be implemented by aspects of the wireless communications system 100 and the wireless communications system 200 as described with reference to FIGS. 1-3. For instance, in the example of FIG. 5, a UE 115-d may communicate with a first network function 505 and a second network function 510, which may be examples of corresponding devices described herein, including with reference to FIG. 1, FIG. 2, and FIG. 3. In the following description of the process flow 500, the operations between the UE 115-d, the first network function 505, and a second network function 510 may be performed in a different order than the example shown, or the operations between the UE 115-d, the first network function 505, and a second network function 510 may be performed in different orders at different times. Some operations may also be omitted form the process flow 500, and other operations may be added to the process flow 500.

At 515, the UE 115-d may transmit, to the first network function 505 of a first network and via a first access, a request to establish a PDU session for communications between the UE 115-d and second network function 510 over a first access. The request may include a request to establish a connection with the second network function 510 via a second access different from the first access.

In some examples, the first network may be a 3GPP network, the first network function 505 may be an SMF, and the second network function 510 may be a UPF. In such examples, the first access may be integrated in the first network and the second access may be non-integrated in the first network. For example, the first access may be a 3GPP access and the second access may be a non-integrated non-3GPP access.

At 520, the first network function 505 may establish the PDU session for communications between the UE 115-d and the second network function 510 based on receiving the request to establish the PDU session.

At 525, the first network function 505 may transmit an indication of a first set of rules for communications between the UE 115-d and the second network function 510 using the second access if the first access is unavailable to the UE 115-d. The first network function may also transmit an indication of a second set of rules for communications between the UE 115-d and the second network function 510 using the second access if the first access is unavailable to the second network function 510. In some examples, the first set of rules include ATSSS rules and the second set of rules include N4 rules.

At 530, the UE 115-d may establish a first connection with the second network function 510 via the first access and may establish a second connection with the second network function 510 via the second access. In some examples, the first connection and the second connection may be an MPQUIC connection or an MPTCP connection.

At 535, the second network function 510 may transmit, to the first network function 505, an indication of activity of the UE 115-d over the first access in accordance with the rules. For example, the second network function 510 may indicate to the first network function 505 that the UE 115-d has been inactive over the first access.

At 540, the first network function 505 may transmit, to the second network function 510, an indication of an availability of the UE 115-d for communications with the second network function 510 over the first access. For example, the first network function 505 may indicate to the second network function 510 that the UE 115-d is unavailable over the first access.

At 545, the second network function 510 may adjust the second connection between the UE 115-d and the second network function 510 that uses the second access based on the rules, the indication of an availability of the UE 115-d, or both. For example, the second network function 510 may terminate the second connection immediately upon receiving the indication of the availability of the UE 115-d over the first access, may terminate the second connection in accordance with (e.g., after) a duration upon receiving the indication of the availability of the UE 115-d over the first access, or may maintain the second connection.

At 550, the UE 115-d may adjust the second connection in accordance with the rules and based on an expiration of a timer. For example, the UE 115-d may terminate the second connection immediately upon expiration of the timer, may terminate the second connection in accordance with (e.g., after) a duration upon expiration of the timer, or may maintain the second connection. In some examples, the timer may be a 3GPPA session timer.

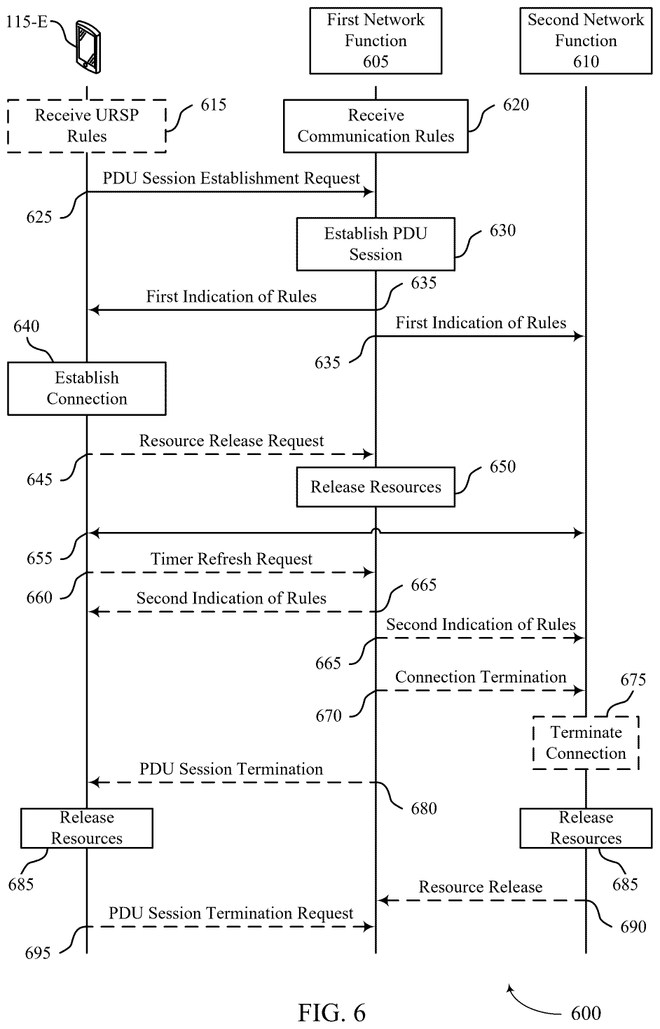

FIG. 6 shows an example of a process flow 600 that supports protocol data unit sessions using a non-integrated access in accordance with one or more aspects of the present disclosure. The process flow 600 may implement or be implemented by aspects of the wireless communications system 100 and the wireless communications system 200 as described with reference to FIG. 1, FIG. 2, and FIG. 4. For instance, in the example of FIG. 6, a UE 115-e may communicate with a first network function 605 and a second network function 610, which may be examples of corresponding devices described herein, including with reference to FIG. 1, FIG. 2, and FIG. 4. In the following description of the process flow 600, the operations between the UE 115-e, the first network function 605, and a second network function 610 may be performed in a different order than the example shown, or the operations between the UE 115-e, the first network function 605, and a second network function 610 may be performed in different orders at different times. Some operations may also be omitted form the process flow 600, and other operations may be added to the process flow 600.

In some examples, the first network function 605 may be an SMF, and the second network function may be a UPF. In the example of FIG. 6, the UE 115-e may be capable of communicating with the second network function 610 via a first access and a second access. In such examples, the first access may be integrated in the first network and the second access may be non-integrated in the first network. The first network may be a 3GPP network, the first access may be a 3GPP access, and the second access may be a non-integrated non-3GPP access.

At 615, the UE 115-e may receive an indication of rules for establishing a PDU session for communications between the UE 115-e and the second network function 610 using only the second access. In some examples, the rules may include extended URSP rules. The UE 115-e may receive the indication of the rules from a network function of the first network. For example, a PCF (not shown) of the first network may indicate the extended URSP rules to the UE 115-e.

At 620, the first network function 605 may receive an indication of rules for communications with the second network function 610 using a first access and using the second access, where the second access is different from the first access. In some examples, the rules may include PCC rules. The first network function 605 may receive the indication of the rules from a network function of the first network. For example, a PCF (not shown) of the first network may indicate the extended URSP rules to the first network function 605.

At 625, the UE 115-e may transmit, to the first network function 605 of the first network and via the first access, a request to establish a PDU session for communications between the UE 115-e and the second network function 610. The request may include a request to establish a connection with the second network function 610 using only the second access. In some examples, the UE 115-e may transmit the request using a DNN.

At 630, the first network function 605 may establish the PDU session for communications between the UE and the second network function 610 based on receiving the request to establish the PDU session from the UE 115-e. The request may include a request to establish the connection with the second network function 610 using only the second access.

At 635, the first network function 605 may transmit an indication of a first set of rules for communications between the UE 115-e and the second network function 610 using only the second access to the UE 115-e. Additionally, at 635, the first network function 605 may transmit an indication of a second set of rules for communications between the UE 115-e and the second network function 610 using only the second access to the second network function 610. In some examples, the first set of rules may include extended ATSS rules and the second set of rules may include extended N4 rules.

At 640, the UE 115-e may establish the connection with the second network function 610 via the second access. In some examples, the connection may be an MPQUIC connection or an MPTCP connection.

At 645, the UE 115-e may transmit, to the first network function 605 and via the first access, a request to release one or more first resources for the PDU session. In some examples, the one or more first resources may be associated with the first access.

At 650, the first network function 605 may release one or more first resources for the PDU session based on receiving, from the UE 115-e and via the first access, the request to release the one or more first resources associated with the first access.

At 655, the UE 115-e may communicate with the second network function 610 via only the second access in accordance with the indication of rules. For example, the UE 115-e may communicate with the second network function 610 in accordance with a timer. In some examples, the timer is predefined at the UE 115-e. In some other examples, the first network function 605 indicates the timer to the UE 115-e via the indication of rules.

At 660, the UE 115-e may transmit, to the first network function 605 via the first access and prior to an expiration of the timer, a request to refresh the timer. In some examples, the UE 115-e may transmit the request via a PDU session modification request message.

At 665, the first network function 605 may transmit a second indication of rules including a refreshed timer. For example, the first network function 605 may transmit a second indication of the first set of rules for communications between the UE 115-e and the second network function 610 using only the second access to the UE 115-e. Additionally, at 665, the first network function 605 may transmit a second indication of the second set of rules for communications between the UE 115-e and the second network function 610 using only the second access to the second network function 610. In some examples, the first set of rules may include extended ATSS rules and the second set of rules may include extended N4 rules.

At 670, the first network function 605 may transmit, to the second network function 610, an indication to terminate the connection between the UE 115-e and the second network function 610 that uses the second access based on one or more local policies at the first network function 605, a timer associated with communications between the UE 115-e and the second network function 610 via the second access, or both. At 675, the second network function 610 may terminate the connection over the second access based on receiving an indication from the first network function 605 to terminate the connection.

At 680, the first network function 605 may transmit, to the UE 115-e and prior to the expiration of the timer associated with communications between the UE 115-e and the second network function 610 via the second access, a PDU session release message indicating that the PDU session is terminated.

At 685, the UE 115-e and the second network function 610 may release one or more second resources for the PDU session based on the expiration of the timer. In some examples, the one or more second resources may be associated with the second access.

In some examples where the first access is not available at the UE 115-e, at 690, the second network function 610 may transmit, to the first network function 605, an indication that the one or more second resources for the PDU session have been released. In some other examples where the first access is available at the UE, at 695, the UE 115-e may transmit, to the first network function 605, a request to terminate the connection of the PDU session.

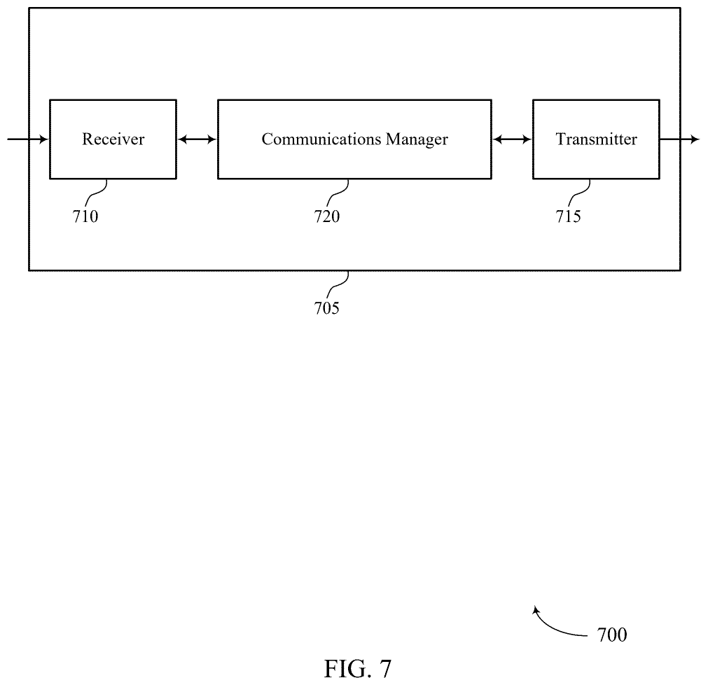

FIG. 7 shows a block diagram 700 of a device 705 that supports protocol data unit sessions using a non-integrated access in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PDU sessions using a non-integrated access). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PDU sessions using a non-integrated access). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of PDU sessions using a non-integrated access as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting, to a first network function of a first network and via a first access, a request to establish a PDU session for communications between the UE and a second network function over a first access, the request including a request to establish a connection with the second network function via a second access different from the first access. The communications manager 720 is capable of, configured to, or operable to support a means for receiving, from a first network function, an indication of rules for communications between the UE and the second network function using the second access if the first access is unavailable. The communications manager 720 is capable of, configured to, or operable to support a means for establishing a first connection with the second network function via the first access and a second connection with the second network function via the second access. The communications manager 720 is capable of, configured to, or operable to support a means for adjusting the second connection in accordance with the rules and based on an expiration of a timer.

Additionally, or alternatively, the communications manager 720 may support wireless communications in accordance with examples as disclosed herein. For example, the communications manager 720 is capable of, configured to, or operable to support a means for transmitting, to a first network function of a first network and via a first access, a request to establish a PDU session for communications between the UE and a second network function, the request including a request to establish a connection with the second network function using only a second access different from the first access. The communications manager 720 is capable of, configured to, or operable to support a means for receiving an indication of rules for communicating with the second network function using only the second access. The communications manager 720 is capable of, configured to, or operable to support a means for establishing a connection with a second network function via the second access. The communications manager 720 is capable of, configured to, or operable to support a means for transmitting, to the first network function and via the first access, a request to release one or more first resources for the PDU session, the one or more first resources associated with the first access. The communications manager 720 is capable of, configured to, or operable to support a means for communicating with the second network function via only the second access in accordance with the indication of rules. The communications manager 720 is capable of, configured to, or operable to support a means for releasing one or more second resources for the PDU session based on an expiration of a timer, the one or more second resources associated with the second access.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

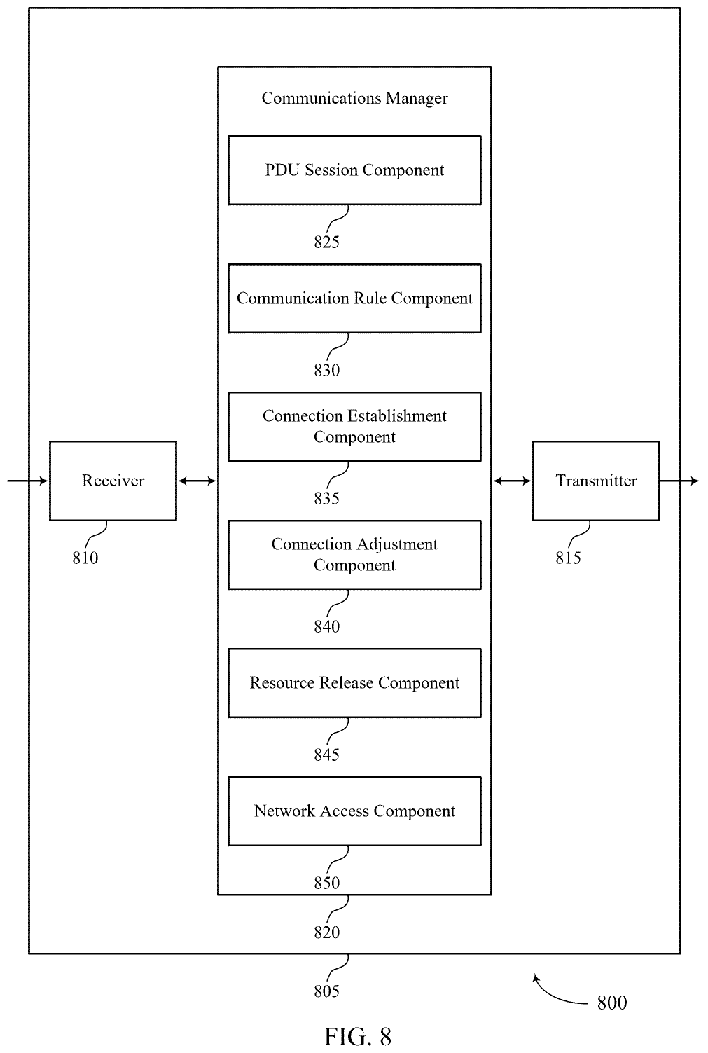

FIG. 8 shows a block diagram 800 of a device 805 that supports PDU sessions using a non-integrated access in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to PDU sessions using a non-integrated access). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to PDU sessions using a non-integrated access). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of PDU sessions using a non-integrated access as described herein. For example, the communications manager 820 may include a PDU session component 825, a communication rule component 830, a connection establishment component 835, a connection adjustment component 840, a resource release component 845, a network access component 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The PDU session component 825 is capable of, configured to, or operable to support a means for transmitting, to a first network function of a first network and via a first access, a request to establish a PDU session for communications between the UE and a second network function over a first access, the request including a request to establish a connection with the second network function via a second access different from the first access. The communication rule component 830 is capable of, configured to, or operable to support a means for receiving, from a first network function, an indication of rules for communications between the UE and the second network function using the second access if the first access is unavailable. The connection establishment component 835 is capable of, configured to, or operable to support a means for establishing a first connection with the second network function via the first access and a second connection with the second network function via the second access. The connection adjustment component 840 is capable of, configured to, or operable to support a means for adjusting the second connection in accordance with the rules and based on an expiration of a timer.

Additionally, or alternatively, the communications manager 820 may support wireless communications in accordance with examples as disclosed herein. The PDU session component 825 is capable of, configured to, or operable to support a means for transmitting, to a first network function of a first network and via a first access, a request to establish a PDU session for communications between the UE and a second network function, the request including a request to establish a connection with the second network function using only a second access different from the first access. The communication rule component 830 is capable of, configured to, or operable to support a means for receiving an indication of rules for communicating with the second network function using only the second access. The connection establishment component 835 is capable of, configured to, or operable to support a means for establishing a connection with a second network function via the second access. The resource release component 845 is capable of, configured to, or operable to support a means for transmitting, to the first network function and via the first access, a request to release one or more first resources for the PDU session, the one or more first resources associated with the first access. The network access component 850 is capable of, configured to, or operable to support a means for communicating with the second network function via only the second access in accordance with the indication of rules. The resource release component 845 is capable of, configured to, or operable to support a means for releasing one or more second resources for the PDU session based on an expiration of a timer, the one or more second resources associated with the second access.

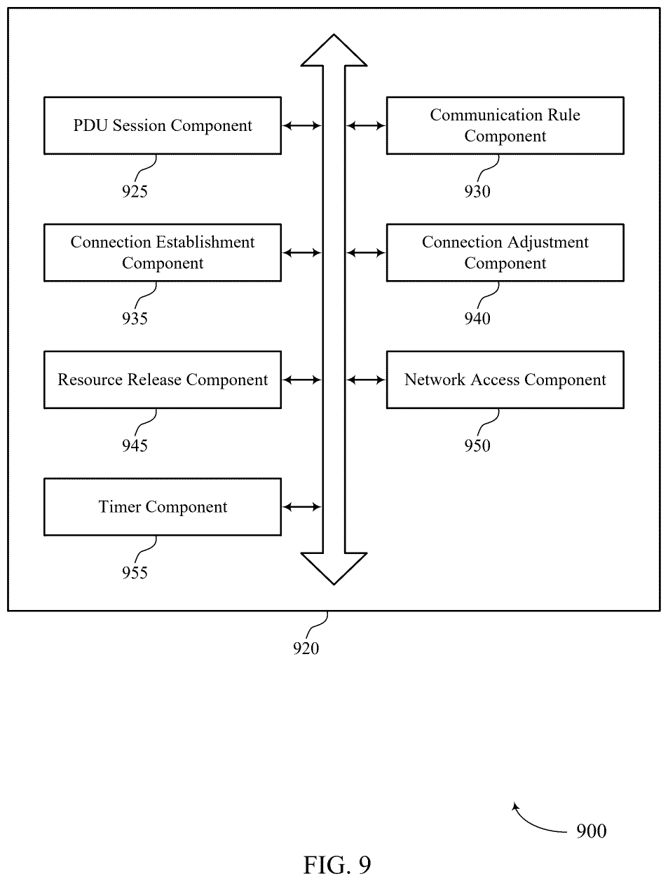

FIG. 9 shows a block diagram 900 of a communications manager 920 that supports protocol data unit sessions using a non-integrated access in accordance with one or more aspects of the present disclosure. The communications manager 920 may be an example of aspects of a communications manager 720, a communications manager 820, or both, as described herein. The communications manager 920, or various components thereof, may be an example of means for performing various aspects of PDU sessions using a non-integrated access as described herein. For example, the communications manager 920 may include a PDU session component 925, a communication rule component 930, a connection establishment component 935, a connection adjustment component 940, a resource release component 945, a network access component 950, a timer component 955, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The PDU session component 925 is capable of, configured to, or operable to support a means for transmitting, to a first network function of a first network and via a first access, a request to establish a PDU session for communications between the UE and a second network function over a first access, the request including a request to establish a connection with the second network function via a second access different from the first access. The communication rule component 930 is capable of, configured to, or operable to support a means for receiving, from a first network function, an indication of rules for communications between the UE and the second network function using the second access if the first access is unavailable. The connection establishment component 935 is capable of, configured to, or operable to support a means for establishing a first connection with the second network function via the first access and a second connection with the second network function via the second access. The connection adjustment component 940 is capable of, configured to, or operable to support a means for adjusting the second connection in accordance with the rules and based on an expiration of a timer.

In some examples, to support adjusting the second connection, the connection adjustment component 940 is capable of, configured to, or operable to support a means for terminating the second connection immediately upon expiration of the timer. In some examples, to support adjusting the second connection, the connection adjustment component 940 is capable of, configured to, or operable to support a means for terminating the second connection in accordance with a duration upon expiration of a timer. In some examples, to support adjusting the second connection, the connection adjustment component 940 is capable of, configured to, or operable to support a means for maintaining the second connection.

In some examples, the first network is a 3GPP network, the first network function is an SMF, and the second network function is a UPF.

In some examples, the first access is a Third Generation Partnership Program (3GPP) access and the second access is a non-integrated non-3GPP access.

In some examples, the first access is integrated in the first network and the second access is non-integrated in the first network.

In some examples, the first connection and the second connection are a multipath QUIC (MPQUIC) connection or a multipath transmission control protocol (MPTCP) connection.

Additionally, or alternatively, the communications manager 920 may support wireless communications in accordance with examples as disclosed herein. In some examples, the PDU session component 925 is capable of, configured to, or operable to support a means for transmitting, to a first network function of a first network and via a first access, a request to establish a PDU session for communications between the UE and a second network function, the request including a request to establish a connection with the second network function using only a second access different from the first access. In some examples, the communication rule component 930 is capable of, configured to, or operable to support a means for receiving an indication of rules for communicating with the second network function using only the second access. In some examples, the connection establishment component 935 is capable of, configured to, or operable to support a means for establishing a connection with a second network function via the second access. The resource release component 945 is capable of, configured to, or operable to support a means for transmitting, to the first network function and via the first access, a request to release one or more first resources for the PDU session, the one or more first resources associated with the first access. The network access component 950 is capable of, configured to, or operable to support a means for communicating with the second network function via only the second access in accordance with the indication of rules. In some examples, the resource release component 945 is capable of, configured to, or operable to support a means for releasing one or more second resources for the PDU session based on an expiration of a timer, the one or more second resources associated with the second access.

In some examples, the communication rule component 930 is capable of, configured to, or operable to support a means for receiving an indication of rules for establishing the PDU session for communications between the UE and the second network function using only the second access, where the rules include extended URSP rules.

In some examples, the PDU session component 925 is capable of, configured to, or operable to support a means for transmitting, to the first network function, a request to terminate the connection of the PDU session.

In some examples, the timer component 955 is capable of, configured to, or operable to support a means for transmitting, to the first network function via the first access and prior to the expiration of the timer, a request to refresh the timer. In some examples, the timer component 955 is capable of, configured to, or operable to support a means for receiving a second indication of rules, the second indication including a refreshed timer.

In some examples, the UE transmits the request via a PDU session modification request message.

In some examples, transmitting the request further includes, transmitting the request using a dedicated data network name (DNN).

In some examples, the UE communicates with the second network function in accordance with the timer, where the timer is predefined.

In some examples, the first network function is an SMF and the second network function is a UPF.

In some examples, the first access is integrated in the first network and the second access is non-integrated in the first network, and where the first network is a 3GPP network.

In some examples, the first access is a 3GPP access and the second access is a non-integrated non-3GPP access.

In some examples, the connection is an MPQUIC connection or an MPTCP connection.

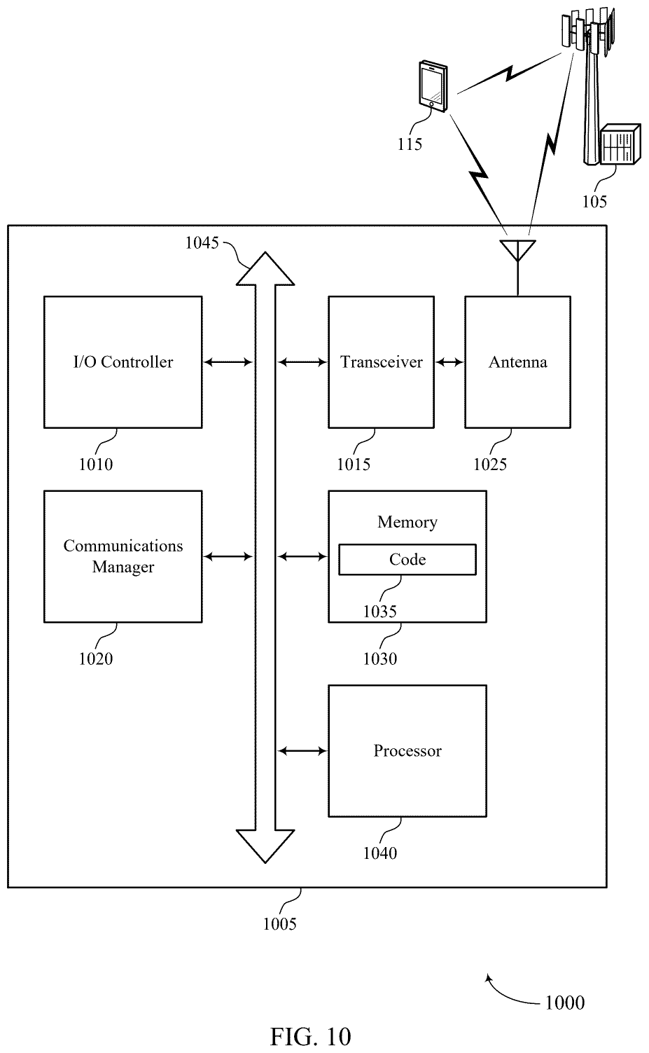

FIG. 10 shows a diagram of a system 1000 including a device 1005 that supports protocol data unit sessions using a non-integrated access in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting PDU sessions using a non-integrated access). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting, to a first network function of a first network and via a first access, a request to establish a PDU session for communications between the UE and a second network function over a first access, the request including a request to establish a connection with the second network function via a second access different from the first access. The communications manager 1020 is capable of, configured to, or operable to support a means for receiving, from a first network function, an indication of rules for communications between the UE and the second network function using the second access if the first access is unavailable. The communications manager 1020 is capable of, configured to, or operable to support a means for establishing a first connection with the second network function via the first access and a second connection with the second network function via the second access. The communications manager 1020 is capable of, configured to, or operable to support a means for adjusting the second connection in accordance with the rules and based on an expiration of a timer.

Additionally, or alternatively, the communications manager 1020 may support wireless communications in accordance with examples as disclosed herein. For example, the communications manager 1020 is capable of, configured to, or operable to support a means for transmitting, to a first network function of a first network and via a first access, a request to establish a PDU session for communications between the UE and a second network function, the request including a request to establish a connection with the second network function using only a second access different from the first access. The communications manager 1020 is capable of, configured to, or operable to support a means for receiving an indication of rules for communicating with the second network function using only the second access. The communications manager 1020 is capable of, configured to, or operable to support a means for establishing a connection with a second network function via the second access. The communications manager 1020 is capable of, configured to, or operable to support a means for transmitting, to the first network function and via the first access, a request to release one or more first resources for the PDU session, the one or more first resources associated with the first access. The communications manager 1020 is capable of, configured to, or operable to support a means for communicating with the second network function via only the second access in accordance with the indication of rules. The communications manager 1020 is capable of, configured to, or operable to support a means for releasing one or more second resources for the PDU session based on an expiration of a timer, the one or more second resources associated with the second access.

By including or configuring the communications manager 1020 in accordance with examples as described herein, the device 1005 may support techniques for improved communication reliability, reduced latency, and improved user experience related to more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of PDU sessions using a non-integrated access as described herein, or the at least one processor 1040 and the at least one memory 1030 may be otherwise configured to, individually or collectively, perform or support such operations.

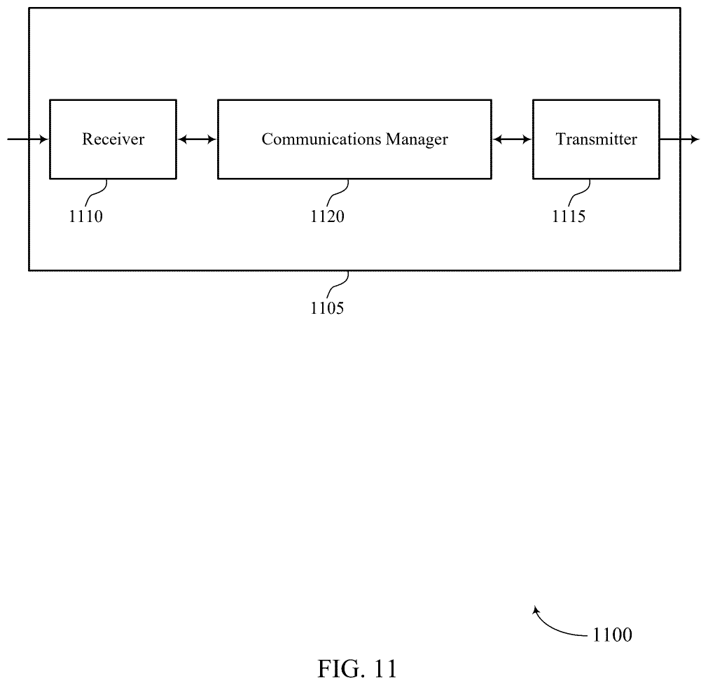

FIG. 11 shows a block diagram 1100 of a device 1105 that supports protocol data unit sessions using a non-integrated access in accordance with one or more aspects of the present disclosure. The device 1105 may be an example of aspects of a first network function as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of PDU sessions using a non-integrated access as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving via a first access, a request to establish a PDU session for communications between a UE and a second network function over a first access, the request including a request to establish a connection with the second network function via a second access different from the first access. The communications manager 1120 is capable of, configured to, or operable to support a means for establishing a PDU session for communications between the UE and the second network function based on receiving the request to establish the PDU session. The communications manager 1120 is capable of, configured to, or operable to support a means for transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

Additionally, or alternatively, the communications manager 1120 may support wireless communications in accordance with examples as disclosed herein. For example, the communications manager 1120 is capable of, configured to, or operable to support a means for receiving an indication of rules for communications with a second network function using a first access and using a second access different from the first access. The communications manager 1120 is capable of, configured to, or operable to support a means for establishing a PDU session for communications between a UE and a second network function based on receiving a request to establish the PDU session, the request including a request to establish a connection with the second network function using only a second access. The communications manager 1120 is capable of, configured to, or operable to support a means for transmitting an indication of a first set of rules for communications between the UE and the second network function using only the second access to the UE and transmitting an indication of a second set of rules for communications between the UE and the second network function using only the second access to the second network function. The communications manager 1120 is capable of, configured to, or operable to support a means for releasing one or more first resources for the PDU session based on receiving, from the UE and via the first access, a request to release the one or more first resources, the one or more first resources associated with the first access.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

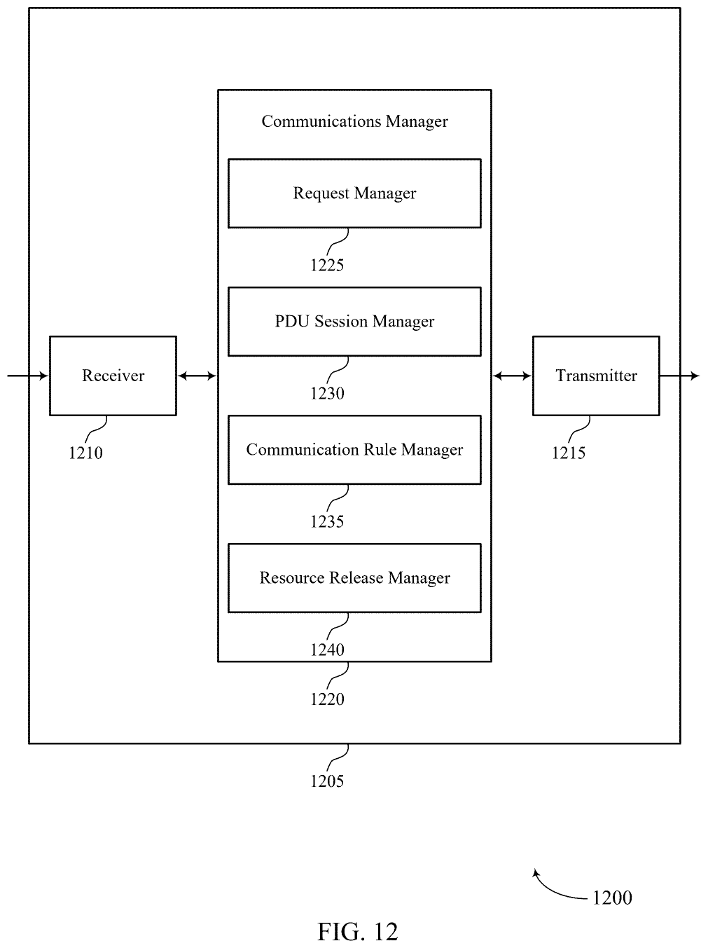

FIG. 12 shows a block diagram 1200 of a device 1205 that supports protocol data unit sessions using a non-integrated access in accordance with one or more aspects of the present disclosure. The device 1205 may be an example of aspects of a device 1105 or a first network function as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of PDU sessions using a non-integrated access as described herein. For example, the communications manager 1220 may include a request manager 1225, a PDU session manager 1230, a communication rule manager 1235, a resource release manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The request manager 1225 is capable of, configured to, or operable to support a means for receiving via a first access, a request to establish a PDU session for communications between a UE and a second network function over a first access, the request including a request to establish a connection with the second network function via a second access different from the first access. The PDU session manager 1230 is capable of, configured to, or operable to support a means for establishing a PDU session for communications between the UE and the second network function based on receiving the request to establish the PDU session. The communication rule manager 1235 is capable of, configured to, or operable to support a means for transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

Additionally, or alternatively, the communications manager 1220 may support wireless communications in accordance with examples as disclosed herein. The communication rule manager 1235 is capable of, configured to, or operable to support a means for receiving an indication of rules for communications with a second network function using a first access and using a second access different from the first access. The PDU session manager 1230 is capable of, configured to, or operable to support a means for establishing a PDU session for communications between a UE and a second network function based on receiving a request to establish the PDU session, the request including a request to establish a connection with the second network function using only a second access. The communication rule manager 1235 is capable of, configured to, or operable to support a means for transmitting an indication of a first set of rules for communications between the UE and the second network function using only the second access to the UE and transmitting an indication of a second set of rules for communications between the UE and the second network function using only the second access to the second network function. The resource release manager 1240 is capable of, configured to, or operable to support a means for releasing one or more first resources for the PDU session based on receiving, from the UE and via the first access, a request to release the one or more first resources, the one or more first resources associated with the first access.

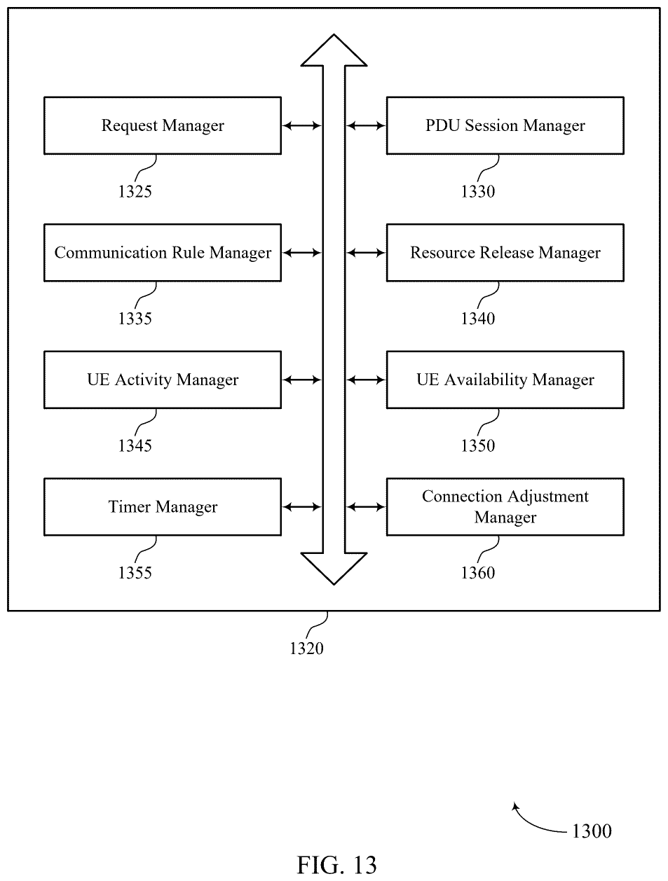

FIG. 13 shows a block diagram 1300 of a communications manager 1320 that supports protocol data unit sessions using a non-integrated access in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of PDU sessions using a non-integrated access as described herein. For example, the communications manager 1320 may include a request manager 1325, a PDU session manager 1330, a communication rule manager 1335, a resource release manager 1340, a UE activity manager 1345, a UE availability manager 1350, a timer manager 1355, a connection adjustment manager 1360, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The request manager 1325 is capable of, configured to, or operable to support a means for receiving via a first access, a request to establish a PDU session for communications between a UE and a second network function over a first access, the request including a request to establish a connection with the second network function via a second access different from the first access. The PDU session manager 1330 is capable of, configured to, or operable to support a means for establishing a PDU session for communications between the UE and the second network function based on receiving the request to establish the PDU session. The communication rule manager 1335 is capable of, configured to, or operable to support a means for transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

In some examples, the UE activity manager 1345 is capable of, configured to, or operable to support a means for receiving, from the second network function, an indication of UE activity using the first access. In some examples, the UE availability manager 1350 is capable of, configured to, or operable to support a means for transmitting, to the second network function, an indication of an availability of the UE for communications with the second network function over the first access.

In some examples, the first set of rules include ATSSS rules and where the second set of rules include N4 rules.

In some examples, the first network function is an SMF and the second network function is a UPF.

In some examples, the first access is integrated in a first network and the second access is non-integrated in the first network, and where the first network is a 3GPP network.

In some examples, the first access is a 3GPP access and the second access is a non-integrated non-3GPP access.

Additionally, or alternatively, the communications manager 1320 may support wireless communications in accordance with examples as disclosed herein. In some examples, the communication rule manager 1335 is capable of, configured to, or operable to support a means for receiving an indication of rules for communications with a second network function using a first access and using a second access different from the first access. In some examples, the PDU session manager 1330 is capable of, configured to, or operable to support a means for establishing a PDU session for communications between a UE and a second network function based on receiving a request to establish the PDU session, the request including a request to establish a connection with the second network function using only a second access. In some examples, the communication rule manager 1335 is capable of, configured to, or operable to support a means for transmitting an indication of a first set of rules for communications between the UE and the second network function using only the second access to the UE and transmitting an indication of a second set of rules for communications between the UE and the second network function using only the second access to the second network function. The resource release manager 1340 is capable of, configured to, or operable to support a means for releasing one or more first resources for the PDU session based on receiving, from the UE and via the first access, a request to release the one or more first resources, the one or more first resources associated with the first access.

In some examples, the timer manager 1355 is capable of, configured to, or operable to support a means for receiving, from UE and via the first access, a request to refresh a timer associated with communications between the UE and the second network function via the second access.

In some examples, the first set of rules include extended ATSSS rules and where the second set of rules include extended N4 rules.

In some examples, the connection adjustment manager 1360 is capable of, configured to, or operable to support a means for transmitting, to the second network function, an indication to terminate a connection between the UE and the second network function that uses the second access based on one or more local policies at the first network function, a timer associated with communications between the UE and the second network function via the second access, or both.

In some examples, the PDU session manager 1330 is capable of, configured to, or operable to support a means for transmitting, to the UE and prior to an expiration of a timer associated with communications between the UE and the second network function via the second access, a PDU session release message indicating that the PDU session is terminated.

In some examples, the first network function is an SMF and the second network function is a UPF.

In some examples, the first access is integrated in a first network and the second access is non-integrated in the first network, and where the first network is a Third-Generation Partnership Program (3GPP) network.

In some examples, the first access is a 3GPP access and the second access is a non-integrated non-3GPP access.

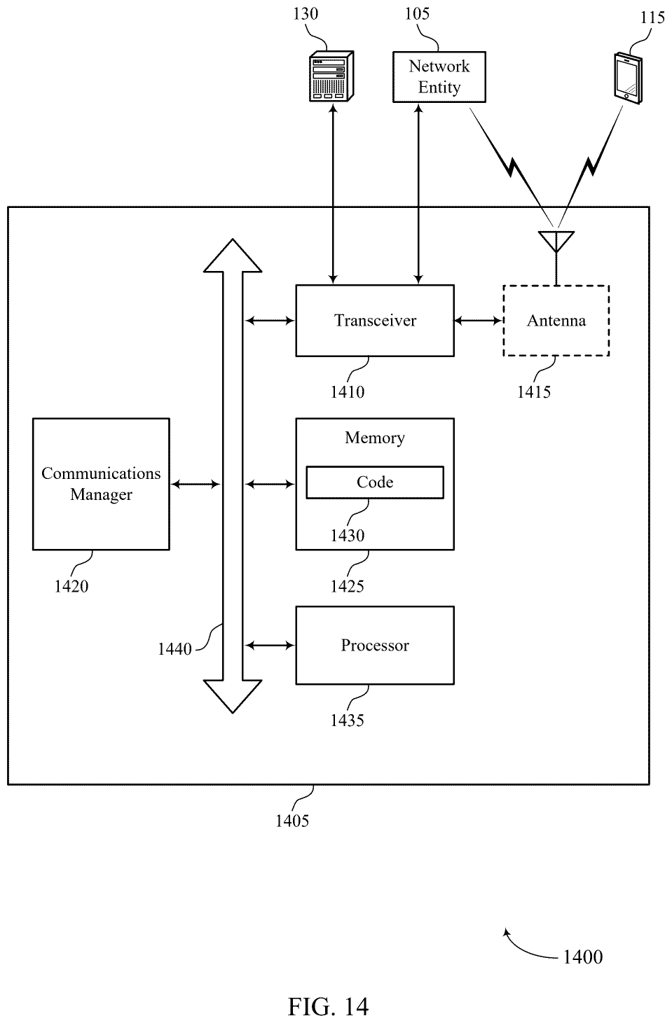

FIG. 14 shows a diagram of a system 1400 including a device 1405 that supports protocol data unit sessions using a non-integrated access in accordance with one or more aspects of the present disclosure. The device 1405 may be an example of or include components of a device 1105, a device 1205, or a first network function as described herein. The device 1405 may include components for bi-directional voice and data communications including components for transmitting and receiving communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting PDU sessions using a non-integrated access). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for receiving via a first access, a request to establish a PDU session for communications between a UE and a second network function over a first access, the request including a request to establish a connection with the second network function via a second access different from the first access. The communications manager 1420 is capable of, configured to, or operable to support a means for establishing a PDU session for communications between the UE and the second network function based on receiving the request to establish the PDU session. The communications manager 1420 is capable of, configured to, or operable to support a means for transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

Additionally, or alternatively, the communications manager 1420 may support wireless communications in accordance with examples as disclosed herein. For example, the communications manager 1420 is capable of, configured to, or operable to support a means for receiving an indication of rules for communications with a second network function using a first access and using a second access different from the first access. The communications manager 1420 is capable of, configured to, or operable to support a means for establishing a PDU session for communications between a UE and a second network function based on receiving a request to establish the PDU session, the request including a request to establish a connection with the second network function using only a second access. The communications manager 1420 is capable of, configured to, or operable to support a means for transmitting an indication of a first set of rules for communications between the UE and the second network function using only the second access to the UE and transmitting an indication of a second set of rules for communications between the UE and the second network function using only the second access to the second network function. The communications manager 1420 is capable of, configured to, or operable to support a means for releasing one or more first resources for the PDU session based on receiving, from the UE and via the first access, a request to release the one or more first resources, the one or more first resources associated with the first access.

By including or configuring the communications manager 1420 in accordance with examples as described herein, the device 1405 may support techniques for improved communication reliability, reduced latency, and improved user experience related to more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of PDU sessions using a non-integrated access as described herein, or the at least one processor 1435 and the at least one memory 1425 may be otherwise configured to, individually or collectively, perform or support such operations.

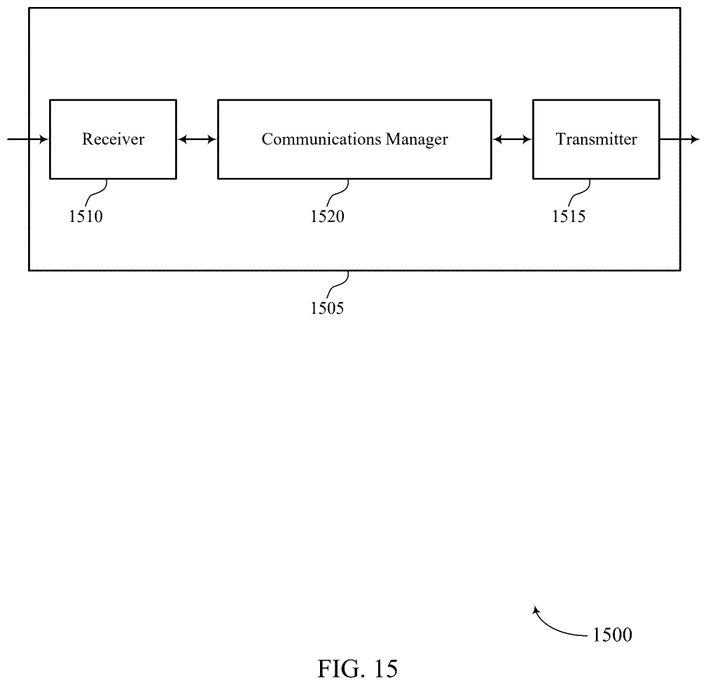

FIG. 15 shows a block diagram 1500 of a device 1505 that supports protocol data unit sessions using a non-integrated access in accordance with one or more aspects of the present disclosure. The device 1505 may be an example of aspects of a second network function as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of PDU sessions using a non-integrated access as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for receiving, from a first network function of the first network, an indication of rules for communications between a UE and the second network function using a second access if a first access is unavailable. The communications manager 1520 is capable of, configured to, or operable to support a means for transmitting, to the first network function, an indication of UE activity using the first access. The communications manager 1520 is capable of, configured to, or operable to support a means for receiving, from the first network function, an indication of an availability of the UE for communications with the second network function using the first access. The communications manager 1520 is capable of, configured to, or operable to support a means for adjusting a connection between the UE and the second network function that uses the second access based on the rules, the indication of an availability of the UE, or both.

Additionally, or alternatively, the communications manager 1520 may support wireless communications in accordance with examples as disclosed herein. For example, the communications manager 1520 is capable of, configured to, or operable to support a means for receiving, from a first network function in communications with a UE via a first access and a second access, an indication of rules for communications between the UE and the second network function using only the second access and using a PDU session. The communications manager 1520 is capable of, configured to, or operable to support a means for communicating with the UE via a connection via only the second access in accordance with the indication of rules. The communications manager 1520 is capable of, configured to, or operable to support a means for releasing one or more resources for the PDU session based on an expiration of a timer, the one or more resources associated with the second access.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for more efficient utilization of communication resources.

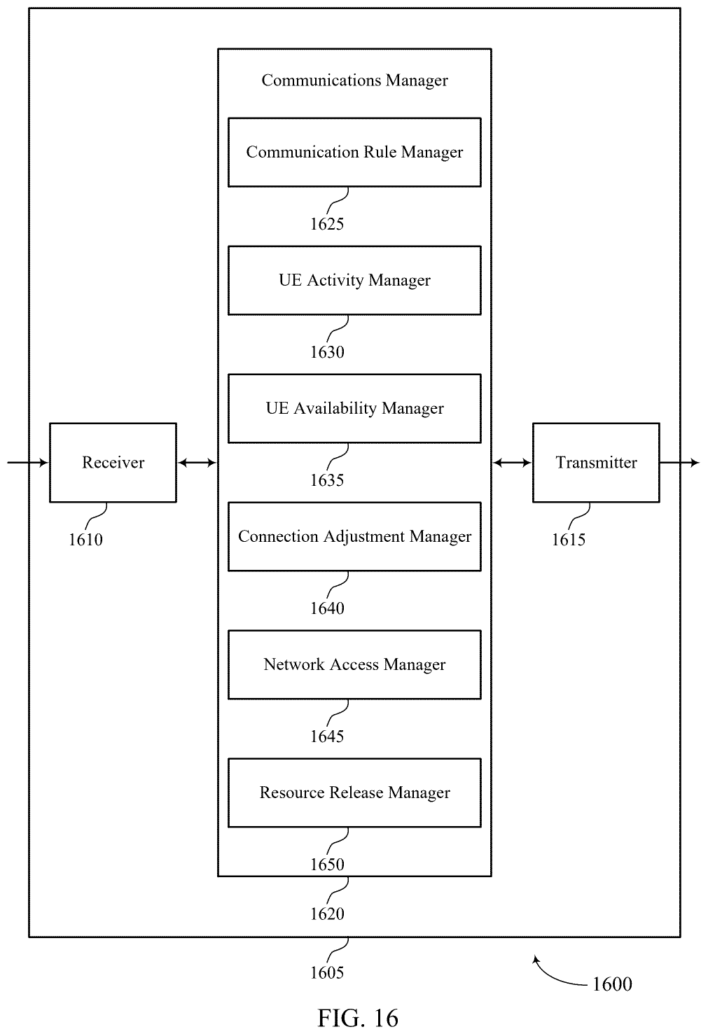

FIG. 16 shows a block diagram 1600 of a device 1605 that supports protocol data unit sessions using a non-integrated access in accordance with one or more aspects of the present disclosure. The device 1605 may be an example of aspects of a device 1505 or a second network function as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of PDU sessions using a non-integrated access as described herein. For example, the communications manager 1620 may include a communication rule manager 1625, a UE activity manager 1630, a UE availability manager 1635, a connection adjustment manager 1640, a network access manager 1645, a resource release manager 1650, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The communication rule manager 1625 is capable of, configured to, or operable to support a means for receiving, from a first network function of the first network, an indication of rules for communications between a UE and the second network function using a second access if a first access is unavailable. The UE activity manager 1630 is capable of, configured to, or operable to support a means for transmitting, to the first network function, an indication of UE activity using the first access. The UE availability manager 1635 is capable of, configured to, or operable to support a means for receiving, from the first network function, an indication of an availability of the UE for communications with the second network function using the first access. The connection adjustment manager 1640 is capable of, configured to, or operable to support a means for adjusting a connection between the UE and the second network function that uses the second access based on the rules, the indication of an availability of the UE, or both.

Additionally, or alternatively, the communications manager 1620 may support wireless communications in accordance with examples as disclosed herein. The communication rule manager 1625 is capable of, configured to, or operable to support a means for receiving, from a first network function in communications with a UE via a first access and a second access, an indication of rules for communications between the UE and the second network function using only the second access and using a PDU session. The network access manager 1645 is capable of, configured to, or operable to support a means for communicating with the UE via a connection via only the second access in accordance with the indication of rules. The resource release manager 1650 is capable of, configured to, or operable to support a means for releasing one or more resources for the PDU session based on an expiration of a timer, the one or more resources associated with the second access.

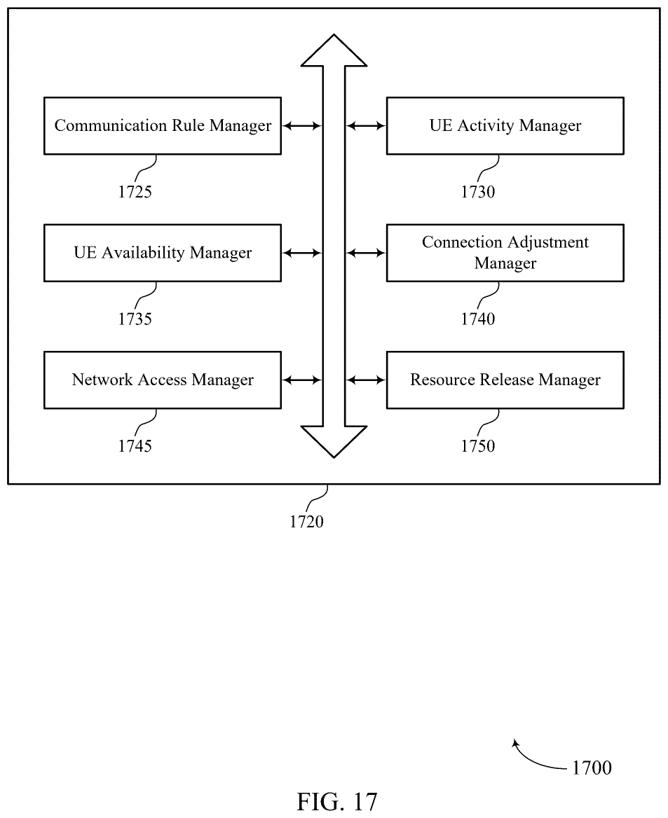

FIG. 17 shows a block diagram 1700 of a communications manager 1720 that supports protocol data unit sessions using a non-integrated access in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of PDU sessions using a non-integrated access as described herein. For example, the communications manager 1720 may include a communication rule manager 1725, a UE activity manager 1730, a UE availability manager 1735, a connection adjustment manager 1740, a network access manager 1745, a resource release manager 1750, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The communication rule manager 1725 is capable of, configured to, or operable to support a means for receiving, from a first network function of the first network, an indication of rules for communications between a UE and the second network function using a second access if a first access is unavailable. The UE activity manager 1730 is capable of, configured to, or operable to support a means for transmitting, to the first network function, an indication of UE activity using the first access. The UE availability manager 1735 is capable of, configured to, or operable to support a means for receiving, from the first network function, an indication of an availability of the UE for communications with the second network function using the first access. The connection adjustment manager 1740 is capable of, configured to, or operable to support a means for adjusting a connection between the UE and the second network function that uses the second access based on the rules, the indication of an availability of the UE, or both.

In some examples, the UE activity manager 1730 is capable of, configured to, or operable to support a means for transmitting, to the first network function, an indication of UE activity using the first access in accordance with the rules. In some examples, the UE availability manager 1735 is capable of, configured to, or operable to support a means for receiving, from the first network function and based on transmitting the indication of UE activity, an indication of an availability of the UE for communications with the second network function over the first access.

In some examples, to support adjusting the connection, the connection adjustment manager 1740 is capable of, configured to, or operable to support a means for terminating the connection immediately upon receiving the indication of an availability of the UE over the first access. In some examples, to support adjusting the connection, the connection adjustment manager 1740 is capable of, configured to, or operable to support a means for terminating the connection in accordance with a duration upon receiving the indication of an availability of the UE over the first access. In some examples, to support adjusting the connection, the connection adjustment manager 1740 is capable of, configured to, or operable to support a means for maintaining the connection.

In some examples, the first network function is an SMF and the second network function is a UPF.

In some examples, the first access is integrated in a first network and the second access is non-integrated in the first network, and where the first network is a 3GPP network.

In some examples, the first access is a 3GPP access and the second access is a non-integrated non-3GPP access.

In some examples, the connection is an MPQUIC connection or an MPTCP connection.

Additionally, or alternatively, the communications manager 1720 may support wireless communications in accordance with examples as disclosed herein. In some examples, the communication rule manager 1725 is capable of, configured to, or operable to support a means for receiving, from a first network function in communications with a UE via a first access and a second access, an indication of rules for communications between the UE and the second network function using only the second access and using a PDU session. The network access manager 1745 is capable of, configured to, or operable to support a means for communicating with the UE via a connection via only the second access in accordance with the indication of rules. The resource release manager 1750 is capable of, configured to, or operable to support a means for releasing one or more resources for the PDU session based on an expiration of a timer, the one or more resources associated with the second access.

In some examples, the resource release manager 1750 is capable of, configured to, or operable to support a means for transmitting, to the first network function, an indication that the one or more resources for the PDU session have been released.

In some examples, the connection adjustment manager 1740 is capable of, configured to, or operable to support a means for terminating the connection over the second access based on receiving an indication from the first network function to terminate the connection.

In some examples, the first network function is an SMF and the second network function is a UPF.

In some examples, the second access is non-integrated in a first network, and where the first network is a 3GPP network.

In some examples, the second access is a non-integrated non-3GPP access.

In some examples, the connection is an MPQUIC connection or an MPTCP connection.

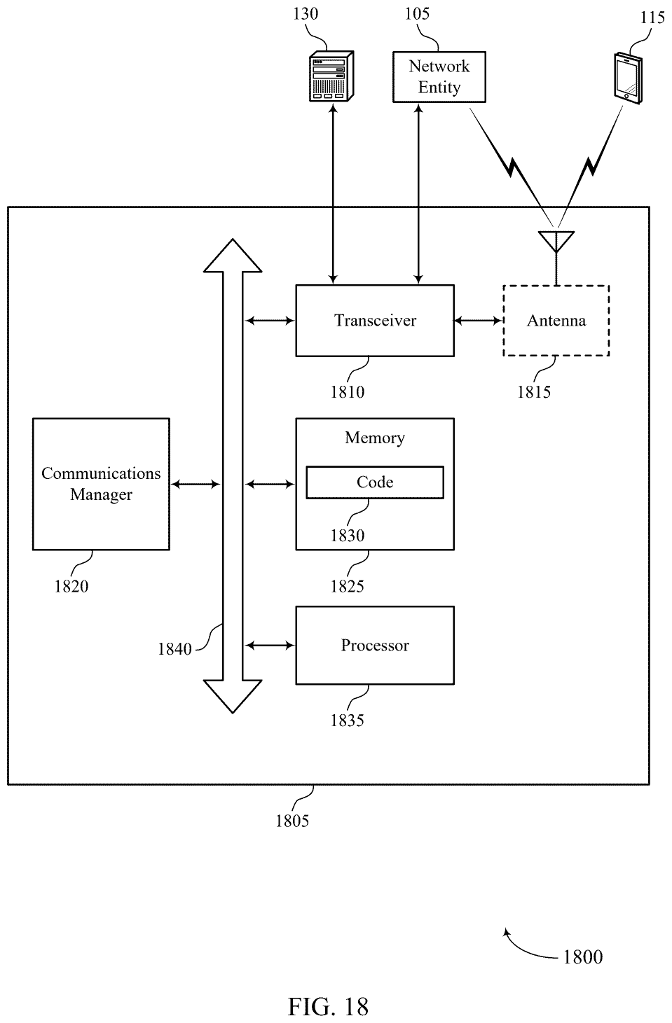

FIG. 18 shows a diagram of a system 1800 including a device 1805 that supports protocol data unit sessions using a non-integrated access in accordance with one or more aspects of the present disclosure. The device 1805 may be an example of or include components of a device 1505, a device 1605, or a second network function as described herein. The device 1805 may include components for bi-directional voice and data communications including components for transmitting and receiving communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some examples, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting PDU sessions using a non-integrated access). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with one or more other network entities 105, and may include a controller or scheduler for controlling communications with UEs 115 (e.g., in cooperation with the one or more other network devices). In some examples, the communications manager 1820 may support an X2 interface within an LTE/LTE-A wireless communications network technology to provide communication between network entities 105.

The communications manager 1820 may support wireless communications in accordance with examples as disclosed herein. For example, the communications manager 1820 is capable of, configured to, or operable to support a means for receiving, from a first network function of the first network, an indication of rules for communications between a UE and the second network function using a second access if a first access is unavailable. The communications manager 1820 is capable of, configured to, or operable to support a means for transmitting, to the first network function, an indication of UE activity using the first access. The communications manager 1820 is capable of, configured to, or operable to support a means for receiving, from the first network function, an indication of an availability of the UE for communications with the second network function using the first access. The communications manager 1820 is capable of, configured to, or operable to support a means for adjusting a connection between the UE and the second network function that uses the second access based on the rules, the indication of an availability of the UE, or both.

Additionally, or alternatively, the communications manager 1820 may support wireless communications in accordance with examples as disclosed herein. For example, the communications manager 1820 is capable of, configured to, or operable to support a means for receiving, from a first network function in communications with a UE via a first access and a second access, an indication of rules for communications between the UE and the second network function using only the second access and using a PDU session. The communications manager 1820 is capable of, configured to, or operable to support a means for communicating with the UE via a connection via only the second access in accordance with the indication of rules. The communications manager 1820 is capable of, configured to, or operable to support a means for releasing one or more resources for the PDU session based on an expiration of a timer, the one or more resources associated with the second access.

By including or configuring the communications manager 1820 in accordance with examples as described herein, the device 1805 may support techniques for improved communication reliability, reduced latency, and improved user experience related to more efficient utilization of communication resources.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of PDU sessions using a non-integrated access as described herein, or the at least one processor 1835 and the at least one memory 1825 may be otherwise configured to, individually or collectively, perform or support such operations.

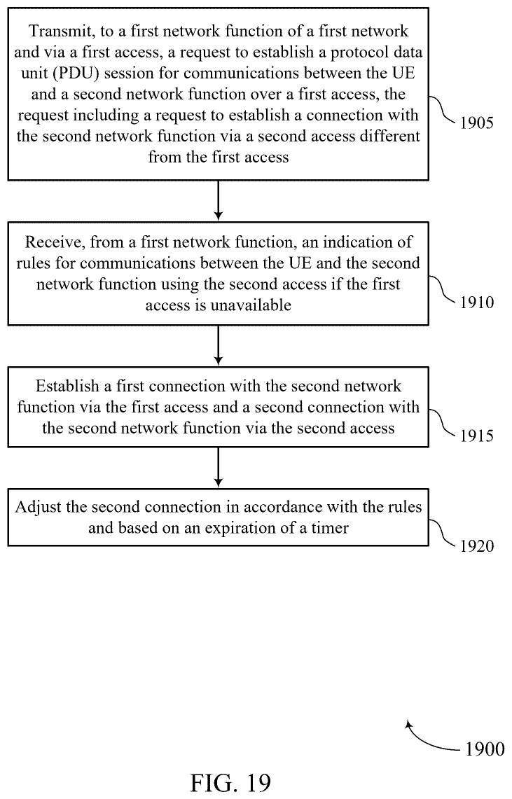

FIG. 19 shows a flowchart illustrating a method 1900 that supports protocol data unit sessions using a non-integrated access in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include transmitting, to a first network function of a first network and via a first access, a request to establish a PDU session for communications between the UE and a second network function over a first access, the request including a request to establish a connection with the second network function via a second access different from the first access. The operations of 1905 may be performed in accordance with examples as disclosed herein. In some examples, aspects of the operations of 1905 may be performed by a PDU session component 925 as described with reference to FIG. 9.

At 1910, the method may include receiving, from a first network function, an indication of rules for communications between the UE and the second network function using the second access if the first access is unavailable. The operations of 1910 may be performed in accordance with examples as disclosed herein. In some examples, aspects of the operations of 1910 may be performed by a communication rule component 930 as described with reference to FIG. 9.

At 1915, the method may include establishing a first connection with the second network function via the first access and a second connection with the second network function via the second access. The operations of 1915 may be performed in accordance with examples as disclosed herein. In some examples, aspects of the operations of 1915 may be performed by a connection establishment component 935 as described with reference to FIG. 9.

At 1920, the method may include adjusting the second connection in accordance with the rules and based on an expiration of a timer. The operations of 1920 may be performed in accordance with examples as disclosed herein. In some examples, aspects of the operations of 1920 may be performed by a connection adjustment component 940 as described with reference to FIG. 9.

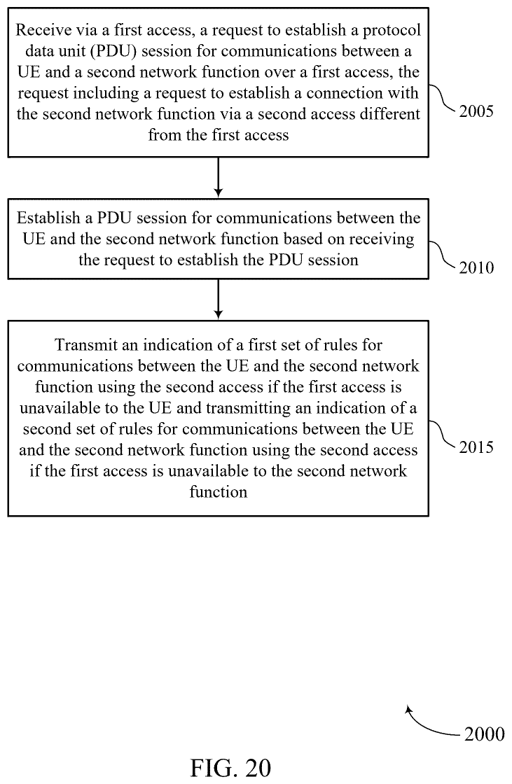

FIG. 20 shows a flowchart illustrating a method 2000 that supports protocol data unit sessions using a non-integrated access in accordance with one or more aspects of the present disclosure. The operations of the method 2000 may be implemented by a first network function or its components as described herein. For example, the operations of the method 2000 may be performed by a first network function as described with reference to FIGS. 1 through 6 and 11 through 14. In some examples, a first network function may execute a set of instructions to control the functional elements of the first network function to perform the described functions. Additionally, or alternatively, the first network function may perform aspects of the described functions using special-purpose hardware.

At 2005, the method may include receiving via a first access, a request to establish a PDU session for communications between a UE and a second network function over a first access, the request including a request to establish a connection with the second network function via a second access different from the first access. The operations of 2005 may be performed in accordance with examples as disclosed herein. In some examples, aspects of the operations of 2005 may be performed by a request manager 1325 as described with reference to FIG. 13.

At 2010, the method may include establishing a PDU session for communications between the UE and the second network function based on receiving the request to establish the PDU session. The operations of 2010 may be performed in accordance with examples as disclosed herein. In some examples, aspects of the operations of 2010 may be performed by a PDU session manager 1330 as described with reference to FIG. 13.

At 2015, the method may include transmitting an indication of a first set of rules for communications between the UE and the second network function using the second access if the first access is unavailable to the UE and transmitting an indication of a second set of rules for communications between the UE and the second network function using the second access if the first access is unavailable to the second network function. The operations of 2015 may be performed in accordance with examples as disclosed herein. In some examples, aspects of the operations of 2015 may be performed by a communication rule manager 1335 as described with reference to FIG. 13.

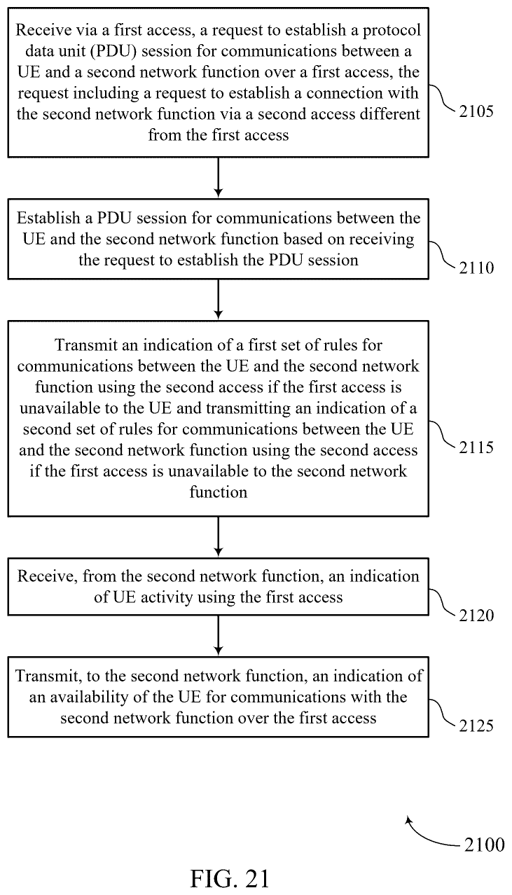

FIG. 21 shows a flowchart illustrating a method 2100 that supports protocol data unit sessions using a non-integrated access in accordance with one or more aspects of the present disclosure. The operations of the method 2100 may be implemented by a first network function or its components as described herein. For example, the operations of the method 2100 may be performed by a first network function as described with reference to FIGS. 1 through 6 and 11 through 14. In some examples, a first network function may execute a set of instructions to control the functional elements of the first network function to perform the described functions. Additionally, or alternatively, the first network function may perform aspects of the described functions using special-purpose hardware.

At 2105, the method may include receiving via a first access, a request to establish a PDU session for communications between a UE and a second network function over a first access, the request including a request to establish a connection with the second network function via a second access different from the first access. The operations of 2105 may be performed in accordance with examples as disclosed herein. In some examples, aspects of the operations of 2105 may be performed by a request manager 1325 as described with reference to FIG. 13.

At 2110, the method may include establishing a PDU session for communications between the UE and the second network function based on receiving the request to establish the PDU session. The operations of 2110 may be performed in accordance with examples as disclosed herein. In some examples, aspects of the operations of 2110 may be performed by a PDU session manager 1330 as described with reference to FIG. 13.

At 2115, the method may include transmitting an indication of a first set of rules for communications between the UE and the second network function using the second access if the first access is unavailable to the UE and transmitting an indication of a second set of rules for communications between the UE and the second network function using the second access if the first access is unavailable to the second network function. The operations of 2115 may be performed in accordance with examples as disclosed herein. In some examples, aspects of the operations of 2115 may be performed by a communication rule manager 1335 as described with reference to FIG. 13.

At 2120, the method may include receiving, from the second network function, an indication of UE activity using the first access. The operations of 2120 may be performed in accordance with examples as disclosed herein. In some examples, aspects of the operations of 2120 may be performed by a UE activity manager 1345 as described with reference to FIG. 13.

At 2125, the method may include transmitting, to the second network function, an indication of an availability of the UE for communications with the second network function over the first access. The operations of 2125 may be performed in accordance with examples as disclosed herein. In some examples, aspects of the operations of 2125 may be performed by a UE availability manager 1350 as described with reference to FIG. 13.

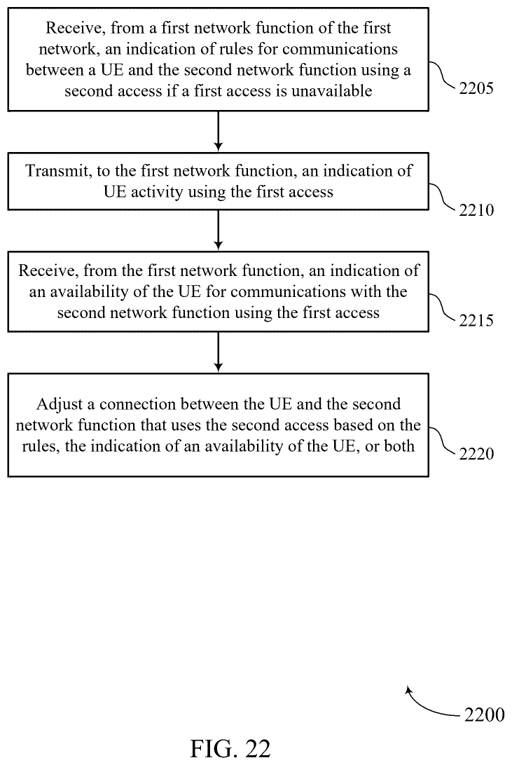

FIG. 22 shows a flowchart illustrating a method 2200 that supports protocol data unit sessions using a non-integrated access in accordance with one or more aspects of the present disclosure. The operations of the method 2200 may be implemented by a second network function or its components as described herein. For example, the operations of the method 2200 may be performed by a second network function as described with reference to FIGS. 1 through 6 and 15 through 18. In some examples, a second network function may execute a set of instructions to control the functional elements of the second network function to perform the described functions. Additionally, or alternatively, the second network function may perform aspects of the described functions using special-purpose hardware.

At 2205, the method may include receiving, from a first network function of the first network, an indication of rules for communications between a UE and the second network function using a second access if a first access is unavailable. The operations of 2205 may be performed in accordance with examples as disclosed herein. In some examples, aspects of the operations of 2205 may be performed by a communication rule manager 1725 as described with reference to FIG. 17.

At 2210, the method may include transmitting, to the first network function, an indication of UE activity using the first access. The operations of 2210 may be performed in accordance with examples as disclosed herein. In some examples, aspects of the operations of 2210 may be performed by a UE activity manager 1730 as described with reference to FIG. 17.

At 2215, the method may include receiving, from the first network function, an indication of an availability of the UE for communications with the second network function using the first access. The operations of 2215 may be performed in accordance with examples as disclosed herein. In some examples, aspects of the operations of 2215 may be performed by a UE availability manager 1735 as described with reference to FIG. 17.

At 2220, the method may include adjusting a connection between the UE and the second network function that uses the second access based on the rules, the indication of an availability of the UE, or both. The operations of 2220 may be performed in accordance with examples as disclosed herein. In some examples, aspects of the operations of 2220 may be performed by a connection adjustment manager 1740 as described with reference to FIG. 17.

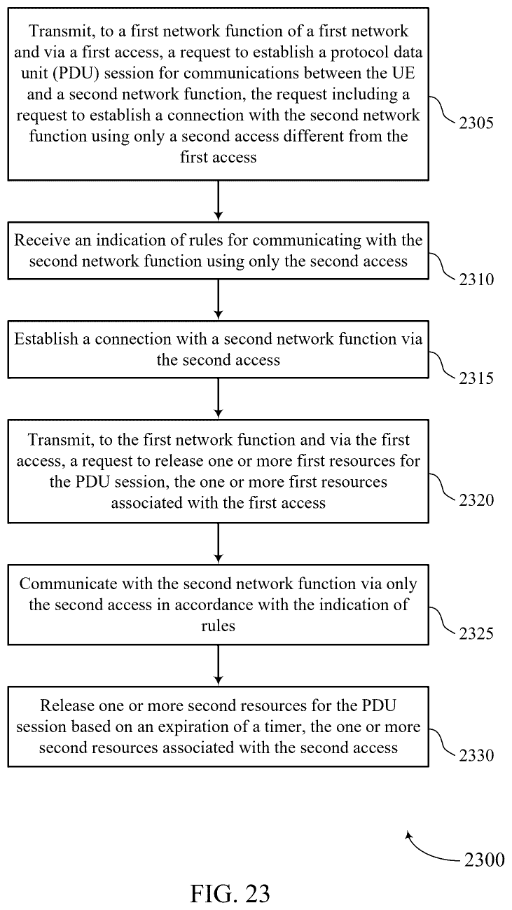

FIG. 23 shows a flowchart illustrating a method 2300 that supports protocol data unit sessions using a non-integrated access in accordance with one or more aspects of the present disclosure. The operations of the method 2300 may be implemented by a UE or its components as described herein. For example, the operations of the method 2300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2305, the method may include transmitting, to a first network function of a first network and via a first access, a request to establish a PDU session for communications between the UE and a second network function, the request including a request to establish a connection with the second network function using only a second access different from the first access. The operations of 2305 may be performed in accordance with examples as disclosed herein. In some examples, aspects of the operations of 2305 may be performed by a PDU session component 925 as described with reference to FIG. 9.

At 2310, the method may include receiving an indication of rules for communicating with the second network function using only the second access. The operations of 2310 may be performed in accordance with examples as disclosed herein. In some examples, aspects of the operations of 2310 may be performed by a communication rule component 930 as described with reference to FIG. 9.

At 2315, the method may include establishing a connection with a second network function via the second access. The operations of 2315 may be performed in accordance with examples as disclosed herein. In some examples, aspects of the operations of 2315 may be performed by a connection establishment component 935 as described with reference to FIG. 9.

At 2320, the method may include transmitting, to the first network function and via the first access, a request to release one or more first resources for the PDU session, the one or more first resources associated with the first access. The operations of 2320 may be performed in accordance with examples as disclosed herein. In some examples, aspects of the operations of 2320 may be performed by a resource release component 945 as described with reference to FIG. 9.

At 2325, the method may include communicating with the second network function via only the second access in accordance with the indication of rules. The operations of 2325 may be performed in accordance with examples as disclosed herein. In some examples, aspects of the operations of 2325 may be performed by a network access component 950 as described with reference to FIG. 9.

At 2330, the method may include releasing one or more second resources for the PDU session based on an expiration of a timer, the one or more second resources associated with the second access. The operations of 2330 may be performed in accordance with examples as disclosed herein. In some examples, aspects of the operations of 2330 may be performed by a resource release component 945 as described with reference to FIG. 9.

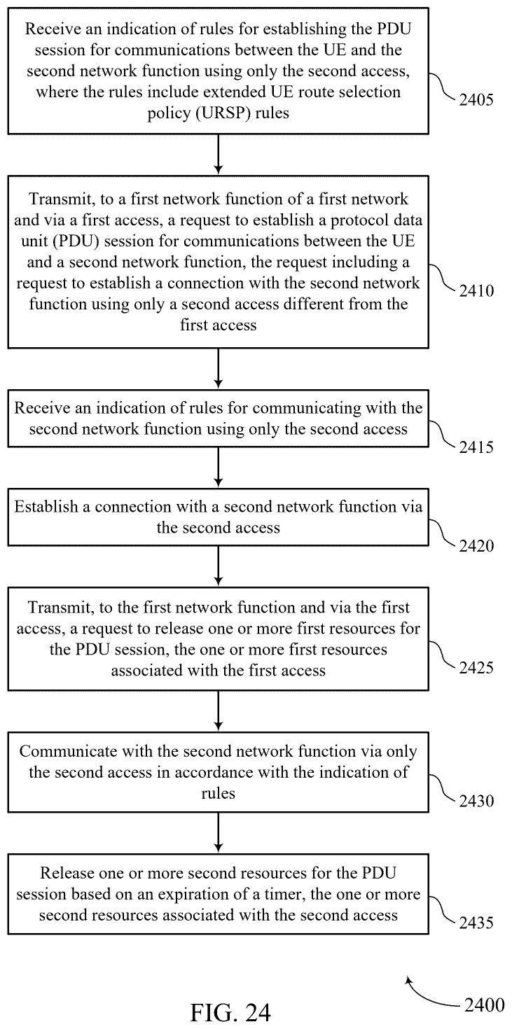

FIG. 24 shows a flowchart illustrating a method 2400 that supports protocol data unit sessions using a non-integrated access in accordance with one or more aspects of the present disclosure. The operations of the method 2400 may be implemented by a UE or its components as described herein. For example, the operations of the method 2400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2405, the method may include receiving an indication of rules for establishing the PDU session for communications between the UE and the second network function using only the second access, where the rules include extended URSP rules. The operations of 2405 may be performed in accordance with examples as disclosed herein. In some examples, aspects of the operations of 2405 may be performed by a communication rule component 930 as described with reference to FIG. 9.

At 2410, the method may include transmitting, to a first network function of a first network and via a first access, a request to establish a PDU session for communications between the UE and a second network function, the request including a request to establish a connection with the second network function using only a second access different from the first access. The operations of 2410 may be performed in accordance with examples as disclosed herein. In some examples, aspects of the operations of 2410 may be performed by a PDU session component 925 as described with reference to FIG. 9.

At 2415, the method may include receiving an indication of rules for communicating with the second network function using only the second access. The operations of 2415 may be performed in accordance with examples as disclosed herein. In some examples, aspects of the operations of 2415 may be performed by a communication rule component 930 as described with reference to FIG. 9.

At 2420, the method may include establishing a connection with a second network function via the second access. The operations of 2420 may be performed in accordance with examples as disclosed herein. In some examples, aspects of the operations of 2420 may be performed by a connection establishment component 935 as described with reference to FIG. 9.

At 2425, the method may include transmitting, to the first network function and via the first access, a request to release one or more first resources for the PDU session, the one or more first resources associated with the first access. The operations of 2425 may be performed in accordance with examples as disclosed herein. In some examples, aspects of the operations of 2425 may be performed by a resource release component 945 as described with reference to FIG. 9.

At 2430, the method may include communicating with the second network function via only the second access in accordance with the indication of rules. The operations of 2430 may be performed in accordance with examples as disclosed herein. In some examples, aspects of the operations of 2430 may be performed by a network access component 950 as described with reference to FIG. 9.

At 2435, the method may include releasing one or more second resources for the PDU session based on an expiration of a timer, the one or more second resources associated with the second access. The operations of 2435 may be performed in accordance with examples as disclosed herein. In some examples, aspects of the operations of 2435 may be performed by a resource release component 945 as described with reference to FIG. 9.

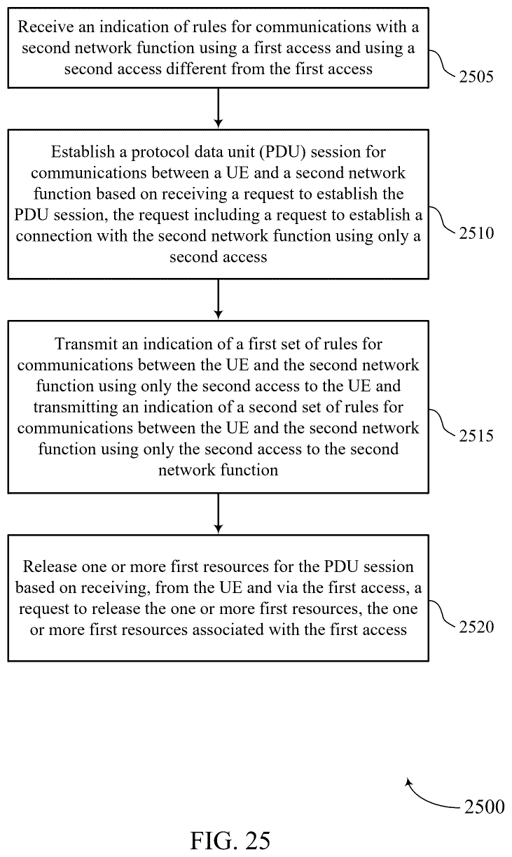

FIG. 25 shows a flowchart illustrating a method 2500 that supports protocol data unit sessions using a non-integrated access in accordance with one or more aspects of the present disclosure. The operations of the method 2500 may be implemented by a first network function or its components as described herein. For example, the operations of the method 2500 may be performed by a first network function as described with reference to FIGS. 1 through 6 and 11 through 14. In some examples, a first network function may execute a set of instructions to control the functional elements of the first network function to perform the described functions. Additionally, or alternatively, the first network function may perform aspects of the described functions using special-purpose hardware.

At 2505, the method may include receiving an indication of rules for communications with a second network function using a first access and using a second access different from the first access. The operations of 2505 may be performed in accordance with examples as disclosed herein. In some examples, aspects of the operations of 2505 may be performed by a communication rule manager 1335 as described with reference to FIG. 13.

At 2510, the method may include establishing a PDU session for communications between a UE and a second network function based on receiving a request to establish the PDU session, the request including a request to establish a connection with the second network function using only a second access. The operations of 2510 may be performed in accordance with examples as disclosed herein. In some examples, aspects of the operations of 2510 may be performed by a PDU session manager 1330 as described with reference to FIG. 13.

At 2515, the method may include transmitting an indication of a first set of rules for communications between the UE and the second network function using only the second access to the UE and transmitting an indication of a second set of rules for communications between the UE and the second network function using only the second access to the second network function. The operations of 2515 may be performed in accordance with examples as disclosed herein. In some examples, aspects of the operations of 2515 may be performed by a communication rule manager 1335 as described with reference to FIG. 13.

At 2520, the method may include releasing one or more first resources for the PDU session based on receiving, from the UE and via the first access, a request to release the one or more first resources, the one or more first resources associated with the first access. The operations of 2520 may be performed in accordance with examples as disclosed herein. In some examples, aspects of the operations of 2520 may be performed by a resource release manager 1340 as described with reference to FIG. 13.

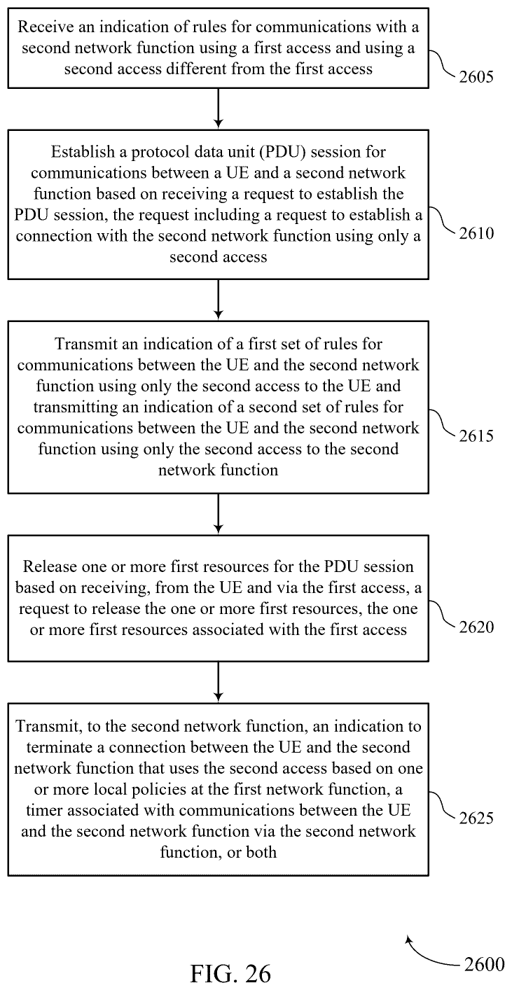

FIG. 26 shows a flowchart illustrating a method 2600 that supports protocol data unit sessions using a non-integrated access in accordance with one or more aspects of the present disclosure. The operations of the method 2600 may be implemented by a first network function or its components as described herein. For example, the operations of the method 2600 may be performed by a first network function as described with reference to FIGS. 1 through 6 and 11 through 14. In some examples, a first network function may execute a set of instructions to control the functional elements of the first network function to perform the described functions. Additionally, or alternatively, the first network function may perform aspects of the described functions using special-purpose hardware.

At 2605, the method may include receiving an indication of rules for communications with a second network function using a first access and using a second access different from the first access. The operations of 2605 may be performed in accordance with examples as disclosed herein. In some examples, aspects of the operations of 2605 may be performed by a communication rule manager 1335 as described with reference to FIG. 13.

At 2610, the method may include establishing a PDU session for communications between a UE and a second network function based on receiving a request to establish the PDU session, the request including a request to establish a connection with the second network function using only a second access. The operations of 2610 may be performed in accordance with examples as disclosed herein. In some examples, aspects of the operations of 2610 may be performed by a PDU session manager 1330 as described with reference to FIG. 13.

At 2615, the method may include transmitting an indication of a first set of rules for communications between the UE and the second network function using only the second access to the UE and transmitting an indication of a second set of rules for communications between the UE and the second network function using only the second access to the second network function. The operations of 2615 may be performed in accordance with examples as disclosed herein. In some examples, aspects of the operations of 2615 may be performed by a communication rule manager 1335 as described with reference to FIG. 13.

At 2620, the method may include releasing one or more first resources for the PDU session based on receiving, from the UE and via the first access, a request to release the one or more first resources, the one or more first resources associated with the first access. The operations of 2620 may be performed in accordance with examples as disclosed herein. In some examples, aspects of the operations of 2620 may be performed by a resource release manager 1340 as described with reference to FIG. 13.

At 2625, the method may include transmitting, to the second network function, an indication to terminate a connection between the UE and the second network function that uses the second access based on one or more local policies at the first network function, a timer associated with communications between the UE and the second network function via the second access, or both. The operations of 2625 may be performed in accordance with examples as disclosed herein. In some examples, aspects of the operations of 2625 may be performed by a connection adjustment manager 1360 as described with reference to FIG. 13.

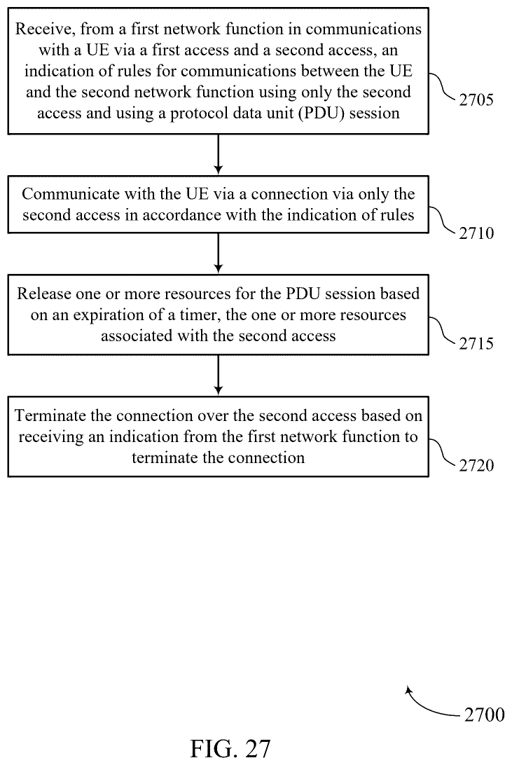

FIG. 27 shows a flowchart illustrating a method 2700 that supports protocol data unit sessions using a non-integrated access in accordance with one or more aspects of the present disclosure. The operations of the method 2700 may be implemented by a second network function or its components as described herein. For example, the operations of the method 2700 may be performed by a second network function as described with reference to FIGS. 1 through 6 and 15 through 18. In some examples, a second network function may execute a set of instructions to control the functional elements of the second network function to perform the described functions. Additionally, or alternatively, the second network function may perform aspects of the described functions using special-purpose hardware.

At 2705, the method may include receiving, from a first network function in communications with a UE via a first access and a second access, an indication of rules for communications between the UE and the second network function using only the second access and using a PDU session. The operations of 2705 may be performed in accordance with examples as disclosed herein. In some examples, aspects of the operations of 2705 may be performed by a communication rule manager 1725 as described with reference to FIG. 17.

At 2710, the method may include communicating with the UE via a connection via only the second access in accordance with the indication of rules. The operations of 2710 may be performed in accordance with examples as disclosed herein. In some examples, aspects of the operations of 2710 may be performed by a network access manager 1745 as described with reference to FIG. 17.

At 2715, the method may include releasing one or more resources for the PDU session based on an expiration of a timer, the one or more resources associated with the second access. The operations of 2715 may be performed in accordance with examples as disclosed herein. In some examples, aspects of the operations of 2715 may be performed by a resource release manager 1750 as described with reference to FIG. 17.

At 2720, the method may include terminating the connection over the second access based on receiving an indication from the first network function to terminate the connection. The operations of 2720 may be performed in accordance with examples as disclosed herein. In some examples, aspects of the operations of 2720 may be performed by a connection adjustment manager 1740 as described with reference to FIG. 17.

The following provides an overview of aspects of the present disclosure:

Aspect 1: A method for wireless communications at a UE, comprising: transmitting, to a first network function of a first network and via a first access, a request to establish a PDU session for communications between the UE and a second network function over a first access, the request comprising a request to establish a connection with the second network function via a second access different from the first access; receiving, from a first network function, an indication of rules for communications between the UE and the second network function using the second access if the first access is unavailable; establishing a first connection with the second network function via the first access and a second connection with the second network function via the second access; and adjusting the second connection in accordance with the rules and based at least in part on an expiration of a timer.

Aspect 2: The method of aspect 1, wherein adjusting the second connection further comprises: terminating the second connection immediately upon expiration of the timer; or terminating the second connection in accordance with a duration upon expiration of a timer; or maintaining the second connection.

Aspect 3: The method of any of aspects 1 through 2, wherein the first network is a 3GPP network, the first network function is an SMF, and the second network function is a UPF.

Aspect 4: The method of aspect 3, wherein the first access is a 3GPP access and the second access is a non-integrated non-3GPP access.

Aspect 5: The method of any of aspects 1 through 4, wherein the first access is integrated in the first network and the second access is non-integrated in the first network.

Aspect 6: The method of any of aspects 1 through 5, wherein the first connection and the second connection are an MPQUIC connection or an MPTCP connection.

Aspect 7: A method for wireless communications at a first network function, comprising: receiving via a first access, a request to establish a PDU session for communications between a UE and a second network function over a first access, the request comprising a request to establish a connection with the second network function via a second access different from the first access; establishing a PDU session for communications between the UE and the second network function based at least in part on receiving the request to establish the PDU session; and transmitting an indication of a first set of rules for communications between the UE and the second network function using the second access if the first access is unavailable to the UE and transmitting an indication of a second set of rules for communications between the UE and the second network function using the second access if the first access is unavailable to the second network function.

Aspect 8: The method of aspect 7, further comprising: receiving, from the second network function, an indication of UE activity using the first access; and transmitting, to the second network function, an indication of an availability of the UE for communications with the second network function over the first access.

Aspect 9: The method of any of aspects 7 through 8, wherein the first set of rules comprise ATSSS rules and wherein the second set of rules comprise N4 rules.

Aspect 10: The method of any of aspects 7 through 9, wherein the first network function is an SMF and the second network function is a UPF.

Aspect 11: The method of any of aspects 7 through 10, wherein the first access is integrated in a first network and the second access is non-integrated in the first network, and wherein the first network is a 3GPP network.

Aspect 12: The method of aspect 11, wherein the first access is a 3GPP access and the second access is a non-integrated non-3GPP access.

Aspect 13: A method for wireless communications at a second network function, comprising: receiving, from a first network function of the first network, an indication of rules for communications between a UE and the second network function using a second access if a first access is unavailable; transmitting, to the first network function, an indication of UE activity using the first access; receiving, from the first network function, an indication of an availability of the UE for communications with the second network function using the first access; and adjusting a connection between the UE and the second network function that uses the second access based at least in part on the rules, the indication of an availability of the UE, or both.

Aspect 14: The method of aspect 13, further comprising: transmitting, to the first network function, an indication of UE activity using the first access in accordance with the rules; and receiving, from the first network function and based at least in part on transmitting the indication of UE activity, an indication of an availability of the UE for communications with the second network function over the first access.

Aspect 15: The method of any of aspects 13 through 14, wherein adjusting the connection further comprises: terminating the connection immediately upon receiving the indication of an availability of the UE over the first access; or terminating the connection in accordance with a duration upon receiving the indication of an availability of the UE over the first access; or maintaining the connection.

Aspect 16: The method of any of aspects 13 through 15, wherein the first network function is an SMF and the second network function is a UPF.

Aspect 17: The method of any of aspects 13 through 16, wherein the first access is integrated in a first network and the second access is non-integrated in the first network, and wherein the first network is a 3GPP network.

Aspect 18: The method of aspect 17, wherein the first access is a 3GPP access and the second access is a non-integrated non-3GPP access.

Aspect 19: The method of any of aspects 13 through 18, wherein the connection is an MPQUIC connection or an MPTCP connection.

Aspect 20: A method for wireless communications at a UE, comprising: transmitting, to a first network function of a first network and via a first access, a request to establish a PDU session for communications between the UE and a second network function, the request comprising a request to establish a connection with the second network function using only a second access different from the first access; receiving an indication of rules for communicating with the second network function using only the second access; establishing a connection with a second network function via the second access; transmitting, to the first network function and via the first access, a request to release one or more first resources for the PDU session, the one or more first resources associated with the first access; communicating with the second network function via only the second access in accordance with the indication of rules; and releasing one or more second resources for the PDU session based at least in part on an expiration of a timer, the one or more second resources associated with the second access.

Aspect 21: The method of aspect 20, further comprising: receiving an indication of rules for establishing the PDU session for communications between the UE and the second network function using only the second access, wherein the rules comprise extended URSP rules.

Aspect 22: The method of any of aspects 20 through 21, further comprising: transmitting, to the first network function, a request to terminate the connection of the PDU session.

Aspect 23: The method of any of aspects 20 through 22, further comprising: transmitting, to the first network function via the first access and prior to the expiration of the timer, a request to refresh the timer; and receiving a second indication of rules, the second indication comprising a refreshed timer.

Aspect 24: The method of aspect 23, wherein the UE transmits the request via a PDU session modification request message.

Aspect 25: The method of any of aspects 20 through 24, wherein transmitting the request further comprises, transmitting the request using a dedicated DNN.

Aspect 26: The method of any of aspects 20 through 25, wherein the UE communicates with the second network function in accordance with the timer, wherein the timer is predefined.

Aspect 27: The method of any of aspects 20 through 26, wherein the first network function is an SMF and the second network function is a UPF.

Aspect 28: The method of any of aspects 20 through 27, wherein the first access is integrated in the first network and the second access is non-integrated in the first network, and wherein the first network is a 3GPP network.

Aspect 29: The method of aspect 28, wherein the first access is a 3GPP access and the second access is a non-integrated non-3GPP access.

Aspect 30: The method of any of aspects 20 through 29, wherein the connection is an MPQUIC connection or an MPTCP connection.

Aspect 31: A method for wireless communications at a first network function, comprising: receiving an indication of rules for communications with a second network function using a first access and using a second access different from the first access; establishing a PDU session for communications between a UE and a second network function based at least in part on receiving a request to establish the PDU session, the request comprising a request to establish a connection with the second network function using only a second access; transmitting an indication of a first set of rules for communications between the UE and the second network function using only the second access to the UE and transmitting an indication of a second set of rules for communications between the UE and the second network function using only the second access to the second network function; and releasing one or more first resources for the PDU session based at least in part on receiving, from the UE and via the first access, a request to release the one or more first resources, the one or more first resources associated with the first access.

Aspect 32: The method of aspect 31, further comprising: receiving, from UE and via the first access, a request to refresh a timer associated with communications between the UE and the second network function via the second access.

Aspect 33: The method of any of aspects 31 through 32, wherein the first set of rules comprise extended ATSSS rules and wherein the second set of rules comprise extended N4 rules.

Aspect 34: The method of any of aspects 31 through 33, further comprising: transmitting, to the second network function, an indication to terminate a connection between the UE and the second network function that uses the second access based at least in part on one or more local policies at the first network function, a timer associated with communications between the UE and the second network function via the second access, or both.

Aspect 35: The method of any of aspects 31 through 34, further comprising: transmitting, to the UE and prior to an expiration of a timer associated with communications between the UE and the second network function via the second access, a protocol data unit session release message indicating that the PDU session is terminated.

Aspect 36: The method of any of aspects 31 through 35, wherein the first network function is an SMF and the second network function is a UPF.

Aspect 37: The method of any of aspects 31 through 36, wherein the first access is integrated in a first network and the second access is non-integrated in the first network, and wherein the first network is a 3GPP network.

Aspect 38: The method of aspect 37, wherein the first access is a 3GPP access and the second access is a non-integrated non-3GPP access.

Aspect 39: A method for wireless communications at a second network function, comprising: receiving, from a first network function in communications with a UE via a first access and a second access, an indication of rules for communications between the UE and the second network function using only the second access and using a PDU session; communicating with the UE via a connection via only the second access in accordance with the indication of rules; and releasing one or more resources for the PDU session based at least in part on an expiration of a timer, the one or more resources associated with the second access.

Aspect 40: The method of aspect 39, further comprising: transmitting, to the first network function, an indication that the one or more resources for the PDU session have been released.

Aspect 41: The method of any of aspects 39 through 40, further comprising: terminating the connection over the second access based at least in part on receiving an indication from the first network function to terminate the connection.

Aspect 42: The method of any of aspects 39 through 41, wherein the first network function is an SMF and the second network function is a UPF.

Aspect 43: The method of any of aspects 39 through 42, wherein the second access is non-integrated in a first network, and wherein the first network is a 3GPP network.

Aspect 44: The method of aspect 43, wherein the second access is a non-integrated non-3GPP access.

Aspect 45: The method of any of aspects 39 through 44, wherein the connection is an MPQUIC connection or an MPTCP connection.

Aspect 46: A UE for wireless communications, comprising one or more memories storing processor-executable code, and one or more processors coupled with the one or more memories and individually or collectively operable to execute the code to cause the UE to perform a method of any of aspects 1 through 6.

Aspect 47: A UE for wireless communications, comprising at least one means for performing a method of any of aspects 1 through 6.

Aspect 48: A non-transitory computer-readable medium storing code for wireless communications, the code comprising instructions executable by one or more processors to perform a method of any of aspects 1 through 6.

Aspect 49: A first network function for wireless communications, comprising one or more memories storing processor-executable code, and one or more processors coupled with the one or more memories and individually or collectively operable to execute the code to cause the first network function to perform a method of any of aspects 7 through 12.

Aspect 50: A first network function for wireless communications, comprising at least one means for performing a method of any of aspects 7 through 12.

Aspect 51: A non-transitory computer-readable medium storing code for wireless communications, the code comprising instructions executable by one or more processors to perform a method of any of aspects 7 through 12.

Aspect 52: A second network function for wireless communications, comprising one or more memories storing processor-executable code, and one or more processors coupled with the one or more memories and individually or collectively operable to execute the code to cause the second network function to perform a method of any of aspects 13 through 19.

Aspect 53: A second network function for wireless communications, comprising at least one means for performing a method of any of aspects 13 through 19.

Aspect 54: A non-transitory computer-readable medium storing code for wireless communications, the code comprising instructions executable by one or more processors to perform a method of any of aspects 13 through 19.

Aspect 55: A UE for wireless communications, comprising one or more memories storing processor-executable code, and one or more processors coupled with the one or more memories and individually or collectively operable to execute the code to cause the UE to perform a method of any of aspects 20 through 30.

Aspect 56: A UE for wireless communications, comprising at least one means for performing a method of any of aspects 20 through 30.

Aspect 57: A non-transitory computer-readable medium storing code for wireless communications, the code comprising instructions executable by one or more processors to perform a method of any of aspects 20 through 30.

Aspect 58: A first network function for wireless communications, comprising one or more memories storing processor-executable code, and one or more processors coupled with the one or more memories and individually or collectively operable to execute the code to cause the first network function to perform a method of any of aspects 31 through 38.

Aspect 59: A first network function for wireless communications, comprising at least one means for performing a method of any of aspects 31 through 38.

Aspect 60: A non-transitory computer-readable medium storing code for wireless communications, the code comprising instructions executable by one or more processors to perform a method of any of aspects 31 through 38.

Aspect 61: A second network function for wireless communications, comprising one or more memories storing processor-executable code, and one or more processors coupled with the one or more memories and individually or collectively operable to execute the code to cause the second network function to perform a method of any of aspects 39 through 45.

Aspect 62: A second network function for wireless communications, comprising at least one means for performing a method of any of aspects 39 through 45.

Aspect 63: A non-transitory computer-readable medium storing code for wireless communications, the code comprising instructions executable by one or more processors to perform a method of any of aspects 39 through 45.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a first network function of a first network and via a first access, a request to establish a protocol data unit (PDU) session for communications between the UE and a second network function over a first access, the request comprising a request to establish a connection with the second network function via a second access different from the first access;
receive, from a first network function, an indication of rules for communications between the UE and the second network function using the second access if the first access is unavailable;
establish a first connection with the second network function via the first access and a second connection with the second network function via the second access; and
adjust the second connection in accordance with the rules and based at least in part on an expiration of a timer.

2. The UE of claim 1, wherein, to adjust the second connection, the one or more processors are individually or collectively further operable to execute the code to cause the UE to:
terminate the second connection immediately upon expiration of the timer; or
terminate the second connection in accordance with a duration upon expiration of a timer; or
maintain the second connection.

3. The UE of claim 1, wherein the first network is a Third Generation Partnership Program (3GPP) network, the first network function is a session management function (SMF), and the second network function is a user plane function (UPF).

4. The UE of claim 3, wherein the first access is a Third Generation Partnership Program (3GPP) access and the second access is a non-integrated non-3GPP access.

5. The UE of claim 1, wherein the first access is integrated in the first network and the second access is non-integrated in the first network.

6. The UE of claim 1, wherein the first connection and the second connection are a multipath QUIC (MPQUIC) connection or a multipath transmission control protocol (MPTCP) connection.

7. A first network function, comprising:
one or more memories storing processor-executable code; and
one or more processors coupled with the one or more memories and individually or collectively operable to execute the code to cause the first network function to:
receive via a first access, a request to establish a protocol data unit (PDU) session for communications between a user equipment (UE) and a second network function over a first access, the request comprising a request to establish a connection with the second network function via a second access different from the first access;
establish a PDU session for communications between the UE and the second network function based at least in part on receiving the request to establish the PDU session; and
transmit an indication of a first set of rules for communications between the UE and the second network function using the second access if the first access is unavailable to the UE and transmitting an indication of a second set of rules for communications between the UE and the second network function using the second access if the first access is unavailable to the second network function.

8. The first network function of claim 7, wherein the one or more processors are individually or collectively further operable to execute the code to cause the first network function to:
receive, from the second network function, an indication of UE activity using the first access; and
transmit, to the second network function, an indication of an availability of the UE for communications with the second network function over the first access.

9. The first network function of claim 7, wherein the first set of rules comprise access traffic steering, switching and splitting (ATSSS) rules and wherein the second set of rules comprise N4 rules.

10. The first network function of claim 7, wherein the first network function is a session management function (SMF) and the second network function is a user plane function (UPF).

11. The first network function of claim 7, wherein the first access is integrated in a first network and the second access is non-integrated in the first network, and wherein the first network is a Third-Generation Partnership Program (3GPP) network.

12. The first network function of claim 11, wherein the first access is a 3GPP access and the second access is a non-integrated non-3GPP access.

13. The first network function of claim 7, wherein the PDU session is a multi-access PDU session.

14. A second network function, comprising:
one or more memories storing processor-executable code; and
one or more processors coupled with the one or more memories and individually or collectively operable to execute the code to cause the second network function to:
receive, from a first network function of the first network, an indication of rules for communications between a user equipment (UE) and the second network function using a second access if a first access is unavailable;
transmit, to the first network function, an indication of UE activity using the first access;
receive, from the first network function, an indication of an availability of the UE for communications with the second network function using the first access; and
adjust a connection between the UE and the second network function that uses the second access based at least in part on the rules, the indication of an availability of the UE, or both.

15. The second network function of claim 14, wherein the one or more processors are individually or collectively further operable to execute the code to cause the second network function to:
transmit, to the first network function, an indication of UE activity using the first access in accordance with the rules; and
receive, from the first network function and based at least in part on transmitting the indication of UE activity, an indication of an availability of the UE for communications with the second network function over the first access.

16. The second network function of claim 14, wherein, to adjust the connection, the one or more processors are individually or collectively further operable to execute the code to cause the second network function to:
terminate the connection immediately upon receiving the indication of an availability of the UE over the first access; or
terminate the connection in accordance with a duration upon receiving the indication of an availability of the UE over the first access; or
maintain the connection.

17. The second network function of claim 14, wherein the first network function is a session management function (SMF) and the second network function is a user plane function (UPF).

18. The second network function of claim 14, wherein the first access is integrated in a first network and the second access is non-integrated in the first network, and wherein the first network is a Third-Generation Partnership Program (3GPP) network.

19. The second network function of claim 18, wherein the first access is a 3GPP access and the second access is a non-integrated non-3GPP access.

20. The second network function of claim 14, wherein the connection is a multipath QUIC (MPQUIC) connection or a multipath transmission control protocol (MPTCP) connection.
